(19) United States
(12) Patent Application Publication
(10) Pub. No.: US 2015/0350558 A1
(43) Pub. Date: Dec. 3, 2015

(54) ZOOM LENS SYSTEM, INTERCHANGEABLE LENS APPARATUS AND CAMERA SYSTEM

(71) Applicant: Panasonic Intellectual Property Management Co., Ltd., Osaka (JP)

(72) Inventors: Tsuneo UCHIDA, Chiba (JP); Masafumi SUEYOSHI, Kanagawa (JP)

(21) Appl. No.: 14/823,177

(22) Filed: Aug. 11, 2015

Related U.S. Application Data
(63) Continuation of application No. PCT/JP2014/000858, filed on Feb. 19, 2014.

(30) Foreign Application Priority Data
Feb. 22, 2013 (JP) 2013-032868

(51) Int. Cl. H04N 5/232; G02B 15/14; H04N 5/225; G02B 27/64

(52) U.S. Cl. CPC H04N 5/23296; G02B 27/646; G02B 15/14; H04N 5/2254; H04N 5/23209; H04N 2201/0084

(57) ABSTRACT

A zoom lens system comprising a positive first lens unit, a negative second lens unit, and subsequent lens units composed of three or more lens units and an aperture diaphragm, wherein intervals between adjacent lens units vary in zooming, the first lens unit is composed of two or less lens elements and moves along an optical axis in the zooming, three or more negative lens elements are located between the first lens unit and the aperture diaphragm, and the conditions: 0.30<|BF_{W}/Y_{W}|<1.39 and 1.10<SD_{T}/SD_{W}<2.00 (BF_{W}: back focal length at wide-angle limit, Y_{W}=f_{W}×tan (ω_{W}), f_{W}: focal length of zoom lens system at wide-angle limit, ω_{W}: half view angle at wide-angle limit, SD_{W}: maximum diameter of aperture diaphragm at wide-angle limit, SD_{T}: maximum diameter of aperture diaphragm at telephoto limit) are satisfied.

### CROSS-REFERENCE TO RELATED APPLICATION

This application is a Continuation of International Application No. PCT/JP2014/000858, filed on Feb. 19, 2014, which in turn claims the benefit of Japanese Application No. 2013-032868, filed on Feb. 22, 2013, the disclosures of which applications are incorporated by reference herein.

### BACKGROUND

1. Field

The present disclosure relates to zoom lens systems, interchangeable lens apparatuses, and camera systems.

2. Description of the Related Art

In recent years, interchangeable-lens type digital camera systems (also referred to simply as “camera systems”, hereinafter) have been spreading rapidly. Such interchangeable-lens type digital camera systems realize: taking of high-sensitive and high-quality images; high-speed focusing and high-speed image processing after image taking; and easy replacement of an interchangeable lens apparatus in accordance with a desired scene. Meanwhile, an interchangeable lens apparatus having a zoom lens system that forms an optical image with variable magnification is popular because it allows free change of focal length.

Japanese Laid-Open Patent Publication No. 2012-163914 discloses a zoom lens having a five-unit configuration of positive, negative, negative, positive, and positive, in which a diaphragm is located between a third lens unit and a fourth lens unit, the third lens unit is composed of one negative lens, and focusing is performed by the third lens unit.

Japanese Laid-Open Patent Publication No. 07-318865 discloses a zoom lens having a five-unit configuration of positive, negative, positive, positive, and negative, in which, in zooming from a wide-angle limit to a telephoto limit, a first lens unit and a fifth lens unit move to the object side, and a fourth lens unit is moved in a direction substantially perpendicular to the optical axis to compensate image blur.

Japanese Laid-Open Patent Publication No. 2012-173657 discloses a zoom lens having three lens units of positive, negative, and negative, and subsequent lens units including at least one lens unit, in which focusing is performed by a third lens unit.

### SUMMARY

The present disclosure provides a compact and lightweight zoom lens system having excellent imaging performance. Further, the present disclosure provides an interchangeable lens apparatus and a camera system each employing the zoom lens system.

The novel concepts disclosed herein were achieved in order to solve the foregoing problems in the related art, and herein is disclosed:

a zoom lens system, in order from an object side to an image side, comprising:

a first lens unit having positive optical power;

a second lens unit having negative optical power; and

subsequent lens units composed of three or more lens units and an aperture diaphragm, wherein

intervals between adjacent lens units vary in zooming from a wide-angle limit to a telephoto limit at a time of image taking,

the first lens unit is composed of two or less lens elements, and moves along an optical axis in the zooming,

three or more lens elements having negative optical power are located between the first lens unit and the aperture diaphragm, and

the following conditions (1) and (2) are satisfied:

0.30<|BF_{W}/Y_{W}|<1.39 (1)

1.10<SD_{T}/SD_{W}<2.00 (2)

where

BF_{W} is a back focal length at the wide-angle limit,

Y_{W} is a diagonal image height at the wide-angle limit, expressed by the following formula:

Y_{W}=f_{W}×tan(ω_{W}),

f_{W} is a focal length of the zoom lens system at the wide-angle limit,

ω_{W} is a half view angle at the wide-angle limit,

SD_{W} is a maximum diameter of the aperture diaphragm at the wide-angle limit, and

SD_{T} is a maximum diameter of the aperture diaphragm at the telephoto limit.

The novel concepts disclosed herein were achieved in order to solve the foregoing problems in the related art, and herein is disclosed:

an interchangeable lens apparatus comprising:

a zoom lens system; and

a lens mount section which is connectable to a camera body including an image sensor for receiving an optical image formed by the zoom lens system and converting the optical image into an electric image signal, wherein

the zoom lens system, in order from an object side to an image side, comprises:

a first lens unit having positive optical power;

a second lens unit having negative optical power; and

subsequent lens units composed of three or more lens units and an aperture diaphragm, wherein

intervals between adjacent lens units vary in zooming from a wide-angle limit to a telephoto limit at a time of image taking,

the first lens unit is composed of two or less lens elements, and moves along an optical axis in the zooming,

three or more lens elements having negative optical power are located between the first lens unit and the aperture diaphragm, and

the following conditions (1) and (2) are satisfied:

0.30<|BF_{W}/Y_{W}|<1.39 (1)

1.10<SD_{T}/SD_{W}<2.00 (2)

where

BF_{W} is a back focal length at the wide-angle limit,

Y_{W} is a diagonal image height at the wide-angle limit, expressed by the following formula:

Y_{W}=f_{W}×tan(ω_{W}),

f_{W} is a focal length of the zoom lens system at the wide-angle limit,

ω_{W} is a half view angle at the wide-angle limit,

SD_{W} is a maximum diameter of the aperture diaphragm at the wide-angle limit, and

SD_{T} is a maximum diameter of the aperture diaphragm at the telephoto limit.

The novel concepts disclosed herein were achieved in order to solve the foregoing problems in the related art, and herein is disclosed:

a camera system comprising:

an interchangeable lens apparatus including a zoom lens system; and

a camera body which is detachably connected to the interchangeable lens apparatus via a camera mount section, and includes an image sensor for receiving an optical image formed by the zoom lens system and converting the optical image into an electric image signal, wherein

the zoom lens system, in order from an object side to an image side, comprises:

a first lens unit having positive optical power;

a second lens unit having negative optical power; and

subsequent lens units composed of three or more lens units and an aperture diaphragm, wherein

intervals between adjacent lens units vary in zooming from a wide-angle limit to a telephoto limit at a time of image taking,

the first lens unit is composed of two or less lens elements, and moves along an optical axis in the zooming,

three or more lens elements having negative optical power are located between the first lens unit and the aperture diaphragm, and

the following conditions (1) and (2) are satisfied:

0.30<|BF_{W}/Y_{W}|<1.39 (1)

1.10<SD_{T}/SD_{W}<2.00 (2)

where

BF_{W} is a back focal length at the wide-angle limit,

Y_{W} is a diagonal image height at the wide-angle limit, expressed by the following formula:

Y_{W}=f_{W}×tan(ω_{W}),

f_{W} is a focal length of the zoom lens system at the wide-angle limit,

ω_{W} is a half view angle at the wide-angle limit,

SD_{W} is a maximum diameter of the aperture diaphragm at the wide-angle limit, and

SD_{T} is a maximum diameter of the aperture diaphragm at the telephoto limit.

The zoom lens system according to the present disclosure is compact and lightweight, and has excellent imaging performance.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a zoom lens system according to Embodiment 1 (Numerical Example 1);

FIG. 2 is a longitudinal aberration diagram of an infinity in-focus condition of the zoom lens system according to Numerical Example 1;

FIG. 3 is a lateral aberration diagram of the zoom lens system according to Numerical Example 1 at a telephoto limit in a basic state where image blur compensation is not performed and in an image blur compensation state;

FIG. 4 is a lens arrangement diagram showing an infinity in-focus condition of a zoom lens system according to Embodiment 2 (Numerical Example 2);

FIG. 5 is a longitudinal aberration diagram of an infinity in-focus condition of the zoom lens system according to Numerical Example 2;

FIG. 6 is a lateral aberration diagram of the zoom lens system according to Numerical Example 2 at a telephoto limit in a basic state where image blur compensation is not performed and in an image blur compensation state;

FIG. 7 is a lens arrangement diagram showing an infinity in-focus condition of a zoom lens system according to Embodiment 3 (Numerical Example 3);

FIG. 8 is a longitudinal aberration diagram of an infinity in-focus condition of the zoom lens system according to Numerical Example 3;

FIG. 9 is a lateral aberration diagram of the zoom lens system according to Numerical Example 3 at a telephoto limit in a basic state where image blur compensation is not performed and in an image blur compensation state;

FIG. 10 is a lens arrangement diagram showing an infinity in-focus condition of a zoom lens system according to Embodiment 4 (Numerical Example 4);

FIG. 11 is a longitudinal aberration diagram of an infinity in-focus condition of the zoom lens system according to Numerical Example 4;

FIG. 12 is a lateral aberration diagram of the zoom lens system according to Numerical Example 4 at a telephoto limit in a basic state where image blur compensation is not performed and in an image blur compensation state;

FIG. 13 is a lens arrangement diagram showing an infinity in-focus condition of a zoom lens system according to Embodiment 5 (Numerical Example 5);

FIG. 14 is a longitudinal aberration diagram of an infinity in-focus condition of the zoom lens system according to Numerical Example 5;

FIG. 15 is a lateral aberration diagram of the zoom lens system according to Numerical Example 5 at a telephoto limit in a basic state where image blur compensation is not performed and in an image blur compensation state;

FIG. 16 is a lens arrangement diagram showing an infinity in-focus condition of a zoom lens system according to Embodiment 6 (Numerical Example 6);

FIG. 17 is a longitudinal aberration diagram of an infinity in-focus condition of the zoom lens system according to Numerical Example 6;

FIG. 18 is a lateral aberration diagram of the zoom lens system according to Numerical Example 6 at a telephoto limit in a basic state where image blur compensation is not performed and in an image blur compensation state; and

FIG. 19 is a schematic construction diagram of an interchangeable-lens type digital camera system according to Embodiment 7.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiments 1 to 6

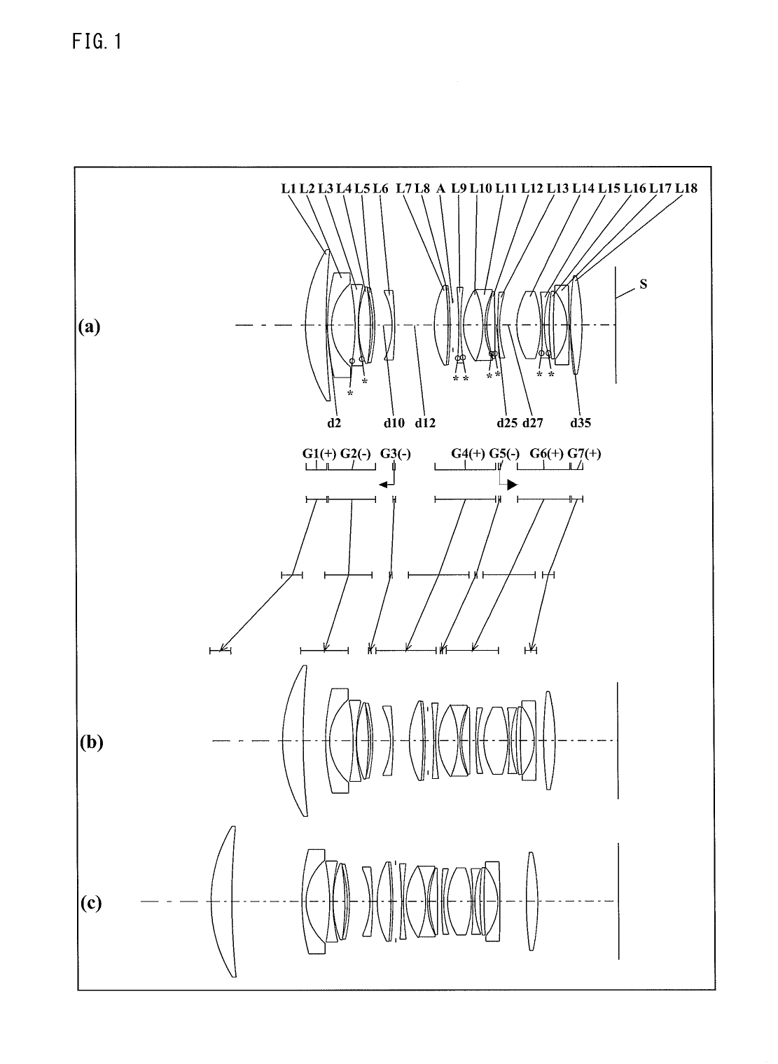

FIGS. 1, 4, 7, 10, 13, and 16 are lens arrangement diagrams of zoom lens systems according to Embodiments 1 to 6, respectively. Each zoom lens system is in an infinity in-focus condition.

In each Fig., part (a) shows a lens configuration at a wide-angle limit (in the minimum focal length condition: focal length f_{W}), part (b) shows a lens configuration at a middle position (in an intermediate focal length condition: focal length f_{M}=\sqrt{(f_{W}*f_{T})}), and part (c) shows a lens configuration at a telephoto limit (in the maximum focal length condition: focal length f_{T}). Further, in each Fig., each bent arrow located between part (a) and part (b) indicates a line obtained by connecting the positions of each lens unit respectively at a wide-angle limit, a middle position and a telephoto limit, in order from the top. In the part between the wide-angle limit and the middle position and the part between the middle position and the telephoto limit, the positions are connected simply with a straight line, and hence this line does not indicate actual motion of each lens unit.

Further, in each Fig., an arrow imparted to a lens unit indicates focusing from an infinity in-focus condition to a close-object in-focus condition. That is, the arrow indicates a direction along which the lens unit moves in focusing from the infinity in-focus condition to the close-object in-focus condition. In each Fig., since the symbols of the respective lens units are imparted to part (a), the arrow indicating focusing is placed beneath each symbol of each lens unit for the convenience sake. However, the direction along which each lens unit moves in focusing in each zooming condition will be hereinafter described in detail for each embodiment.

Each of the zoom lens systems according to Embodiments 1, 2, 5, and 6, in order from the object side to the image side, comprises a first lens unit G1 having positive optical power, a second lens unit G2 having negative optical power, a third lens unit G3 having negative optical power, a fourth lens unit G4 having positive optical power, a fifth lens unit G5 having negative optical power, a sixth lens unit G6 having positive optical power, and a seventh lens unit G7 having positive optical power. In the zoom lens systems according to Embodiments 1, 2, 5, and 6, in zooming, the respective lens units individually move in a direction along the optical axis such that the intervals between the lens units vary. In the zoom lens systems according to Embodiments 1, 2, 5, and 6, these lens units are arranged in a desired optical power allocation, whereby size reduction of the entire lens system is achieved while maintaining excellent optical performance.

The zoom lens system according to Embodiment 3, in order from the object side to the image side, comprises a first lens unit G1 having positive optical power, a second lens unit G2 having negative optical power, a third lens unit G3 having negative optical power, a fourth lens unit G4 having positive optical power, a fifth lens unit G5 having negative optical power, and a sixth lens unit G6 having negative optical power. In the zoom lens system according to Embodiment 3, in zooming, the respective lens units individually move in the direction along the optical axis such that the intervals between the lens units vary. In the zoom lens system according to Embodiment 3, these lens units are arranged in a desired optical power allocation, whereby size reduction of the entire lens system is achieved while maintaining excellent optical performance.

The zoom lens system according to Embodiment 4, in order from the object side to the image side, comprises a first lens unit G1 having positive optical power, a second lens unit G2 having negative optical power, a third lens unit G3 having negative optical power, a fourth lens unit G4 having positive optical power, a fifth lens unit G5 having negative optical power, and a sixth lens unit G6 having positive optical power. In the zoom lens system according to Embodiment 4, in zooming, the respective lens units individually move in the direction along the optical axis such that the intervals between the lens units vary. In the zoom lens system according to Embodiment 4, these lens units are arranged in a desired optical power allocation, whereby size reduction of the entire lens system is achieved while maintaining excellent optical performance.

In each Fig., an asterisk “*” imparted to a particular surface indicates that the surface is aspheric. In each Fig., symbol (+) or (−) imparted to the symbol of each lens unit corresponds to the sign of the optical power of the lens unit. In each Fig., a straight line located on the most right-hand side indicates the position of an image surface S.

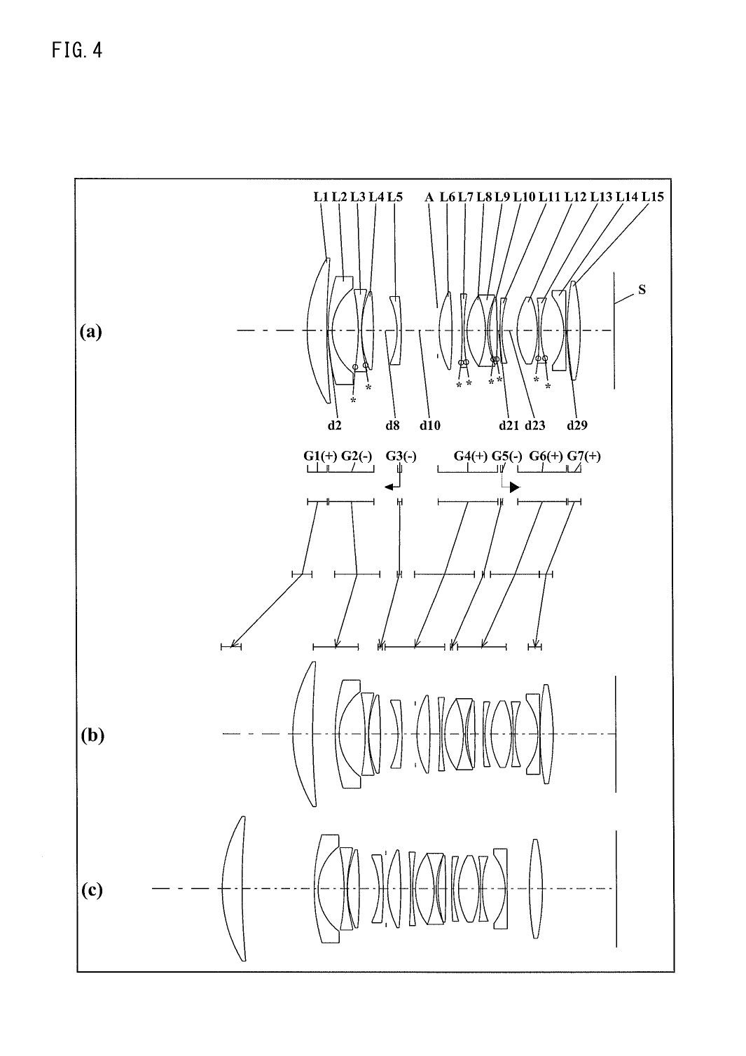

Further, as shown in FIGS. 1, 10, and 13, an aperture diaphragm A is included in the fourth lens unit G4. As shown in FIGS. 4, 7, and 16, an aperture diaphragm A is located on the side closest to the object, in the fourth lens unit G4.

### Embodiment 1

The first lens unit G1 comprises solely a positive meniscus first lens element L1 with the convex surface facing the object side.

The second lens unit G2, in order from the object side to the image side, comprises: a negative meniscus second lens element L2 with the convex surface facing the object side; a bi-concave third lens element L3; a bi-convex fourth lens element L4; and a negative meniscus fifth lens element L5 with the convex surface facing the image side. The third lens element L3 has two aspheric surfaces.

The third lens unit G3 comprises solely a negative meniscus sixth lens element L6 with the convex surface facing the image side.

The fourth lens unit G4, in order from the object side to the image side, comprises: a bi-convex seventh lens element L7; a negative meniscus eighth lens element L8 with the convex surface facing the image side; an aperture diaphragm A; a bi-concave ninth lens element L9; a bi-convex tenth lens element L10; a bi-concave eleventh lens element L11; and a bi-convex twelfth lens element L12. The seventh lens element L7 and the eighth lens element L8 are cemented with each other. In the surface data of the corresponding Numerical Example described later, a surface number 14 is imparted to an adhesive layer between the seventh lens element L7 and the eighth lens element L8. In addition, the tenth lens element L10 and the eleventh lens element L11 are cemented with each other. In the surface data of the corresponding Numerical Example described later, a surface number 21 is imparted to an adhesive layer between the tenth lens element L10 and the eleventh lens element L11. The ninth lens element L9 has two aspheric surfaces, and the twelfth lens element L12 has two aspheric surfaces.

The fifth lens unit G5 comprises solely a negative meniscus thirteenth lens element L13 with the convex surface facing the object side.

The sixth lens unit G6, in order from the object side to the image side, comprises: a bi-convex fourteenth lens element L14; a bi-concave fifteenth lens element L15; a positive meniscus sixteenth lens element L16 with the convex surface facing the object side; and a negative meniscus seventeenth lens element L17 with the convex surface facing the image side. The fifteenth lens element L15 has two aspheric surfaces.

The seventh lens unit G7 comprises solely a bi-convex eighteenth lens element L18.

In zooming from the wide-angle limit to the telephoto limit at the time of image taking, the respective lens units move along the optical axis such that the interval between the first lens unit G1 and the second lens unit G2 increases, the interval between the second lens unit G2 and the third lens unit G3 increases, the interval between the third lens unit G3 and the fourth lens unit G4 decreases, the interval between the fourth lens unit G4 and the fifth lens unit G5 increases, the interval between the fifth lens unit G5 and the sixth lens unit G6 decreases, and the interval between the sixth lens unit G6 and the seventh lens unit G7 increases.

In focusing from the infinity in-focus condition to the close-object in-focus condition, the third lens unit G3 serving as a focusing lens unit moves to the object side along the optical axis, and the fifth lens unit G5 serving as another focusing lens unit moves to the image side along the optical axis.

The ninth lens element L9, which is a part of the fourth lens unit G4, corresponds to an image blur compensating lens unit that moves in a direction perpendicular to the optical axis to optically compensate image blur.

### Embodiment 2

The first lens unit G1 comprises solely a positive meniscus first lens element L1 with the convex surface facing the object side.

The second lens unit G2, in order from the object side to the image side, comprises: a negative meniscus second lens element L2 with the convex surface facing the object side; a bi-concave third lens element L3; and a bi-convex fourth lens element L4. The third lens element L3 has two aspheric surfaces.

The third lens unit G3 comprises solely a negative meniscus fifth lens element L5 with the convex surface facing the image side.

The fourth lens unit G4, in order from the object side to the image side, comprises: an aperture diaphragm A; a bi-convex sixth lens element L6; a bi-concave seventh lens element L7; a bi-convex eighth lens element L8; a bi-concave ninth lens element L9; and a bi-convex tenth lens element L10. The eighth lens element L8 and the ninth lens element L9 are cemented with each other. In the surface data of the corresponding Numerical Example described later, a surface number 17 is imparted to an adhesive layer between the eighth lens element L8 and the ninth lens element L9. The seventh lens element L7 has two aspheric surfaces, and the tenth lens element L10 has two aspheric surfaces.

The fifth lens unit G5 comprises solely a negative meniscus eleventh lens element L11 with the convex surface facing the object side.

The sixth lens unit G6, in order from the object side to the image side, comprises: a bi-convex twelfth lens element L12; a bi-concave thirteenth lens element L13; and a negative meniscus fourteenth lens element L14 with the convex surface facing the image side. The thirteenth lens element L13 has two aspheric surfaces.

The seventh lens unit G7 comprises solely a bi-convex fifteenth lens element L15.

In zooming from the wide-angle limit to the telephoto limit at the time of image taking, the respective lens units move along the optical axis such that the interval between the first lens unit G1 and the second lens unit G2 increases, the interval between the second lens unit G2 and the third lens unit G3 increases, the interval between the third lens unit G3 and the fourth lens unit G4 decreases, the interval between the fourth lens unit G4 and the fifth lens unit G5 increases, the interval between the fifth lens unit G5 and the sixth lens unit G6 decreases, and the interval between the sixth lens unit G6 and the seventh lens unit G7 increases.

In focusing from the infinity in-focus condition to the close-object in-focus condition, the third lens unit G3 serving as a focusing lens unit moves to the object side along the optical axis, and the fifth lens unit G5 serving as another focusing lens unit moves to the image side along the optical axis.

The seventh lens element L7, which is a part of the fourth lens unit G4, corresponds to an image blur compensating lens unit that moves in a direction perpendicular to the optical axis to optically compensate image blur.

### Embodiment 3

The first lens unit G1 comprises solely a positive meniscus first lens element L1 with the convex surface facing the object side.

The second lens unit G2, in order from the object side to the image side, comprises: a negative meniscus second lens element L2 with the convex surface facing the object side; a bi-concave third lens element L3; and a bi-convex fourth lens element L4. The third lens element L3 has two aspheric surfaces.

The third lens unit G3 comprises solely a negative meniscus fifth lens element L5 with the convex surface facing the image side.

The fourth lens unit G4, in order from the object side to the image side, comprises: an aperture diaphragm A; a negative meniscus sixth lens element L6 with the convex surface facing the object side; a bi-convex seventh lens element L7; a bi-concave eighth lens element L8; a bi-convex ninth lens element L9; a bi-concave tenth lens element L10; a positive meniscus eleventh lens element L11 with the convex surface facing the object side; and a bi-convex twelfth lens element L12. The sixth lens element L6 and the seventh lens element L7 are cemented with each other. In the surface data of the corresponding Numerical Example described later, a surface number 13 is imparted to an adhesive layer between the sixth lens element L6 and the seventh lens element L7. In addition, the ninth lens element L9 and the tenth lens element L10 are cemented with each other. In the surface data of the corresponding Numerical Example described later, a surface number 19 is imparted to an adhesive layer between the ninth lens element L9 and the tenth lens element L10. The eleventh lens element L11 has two aspheric surfaces, and the twelfth lens element L12 has an aspheric object side surface.

The fifth lens unit G5 comprises solely a negative meniscus thirteenth lens element L13 with the convex surface facing the object side. The thirteenth lens element L13 has two aspheric surfaces.

The sixth lens unit G6, in order from the object side to the image side, comprises: a negative meniscus fourteenth lens element L14 with the convex surface facing the image side; and a bi-convex fifteenth lens element L15.

In zooming from the wide-angle limit to the telephoto limit at the time of image taking, the respective lens units move along the optical axis such that the interval between the first lens unit G1 and the second lens unit G2 increases, the interval between the second lens unit G2 and the third lens unit G3 decreases, the interval between the third lens unit G3 and the fourth lens unit G4 decreases, the interval between the fourth lens unit G4 and the fifth lens unit G5 increases, and the interval between the fifth lens unit G5 and the sixth lens unit G6 decreases.

In focusing from the infinity in-focus condition to the close-object in-focus condition, the third lens unit G3 serving as a focusing lens unit moves to the object side along the optical axis in any zooming state.

The fifth lens unit G5 corresponds to an image blur compensating lens unit that moves in a direction perpendicular to the optical axis to optically compensate image blur.

### Embodiment 4

The first lens unit G1 comprises solely a positive meniscus first lens element L1 with the convex surface facing the object side.

The second lens unit G2, in order from the object side to the image side, comprises: a negative meniscus second lens element L2 with the convex surface facing the object side; a negative meniscus third lens element L3 with the convex surface facing the object side; and a positive meniscus fourth lens element L4 with the convex surface facing the object side.

The third lens unit G3 comprises solely a negative meniscus fifth lens element L5 with the convex surface facing the image side. The fifth lens element L5 has two aspheric surfaces.

The fourth lens unit G4, in order from the object side to the image side, comprises: a bi-convex sixth lens element L6; an aperture diaphragm A; a negative meniscus seventh lens element L7 with the convex surface facing the object side; a bi-convex eighth lens element L8; and a positive meniscus ninth lens element L9 with the convex surface facing the image side. The sixth lens element L6 has an aspheric image side surface, and the eighth lens element L8 has an aspheric image side surface.

The fifth lens unit G5 comprises solely a negative meniscus tenth lens element L10 with the convex surface facing the object side.

The sixth lens unit G6, in order from the object side to the image side, comprises: a bi-convex eleventh lens element L11; a bi-concave twelfth lens element L12; and a bi-convex thirteenth lens element L13. The twelfth lens element L12 and the thirteenth lens element L13 are cemented with each other. In the surface data of the corresponding Numerical Example described later, a surface number 25 is imparted to an adhesive layer between the twelfth lens element L12 and the thirteenth lens element L13. The eleventh lens element L11 has two aspheric surfaces.

In zooming from the wide-angle limit to the telephoto limit at the time of image taking, the respective lens units move along the optical axis such that the interval between the first lens unit G1 and the second lens unit G2 increases, the interval between the second lens unit G2 and the third lens unit G3 decreases, the interval between the third lens unit G3 and the fourth lens unit G4 decreases, the interval between the fourth lens unit G4 and the fifth lens unit G5 decreases, and the interval between the fifth lens unit G5 and the sixth lens unit G6 increases.

In focusing from the infinity in-focus condition to the close-object in-focus condition, the fifth lens unit G5 serving as a focusing lens unit moves to the image side along the optical axis in any zooming state.

The eighth lens element L8, which is a part of the fourth lens unit G4, corresponds to an image blur compensating lens unit that moves in a direction perpendicular to the optical axis to optically compensate image blur.

### Embodiment 5

The first lens unit G1 comprises solely a positive meniscus first lens element L1 with the convex surface facing the object side.

The second lens unit G2, in order from the object side to the image side, comprises: a negative meniscus second lens element L2 with the convex surface facing the object side; a bi-concave third lens element L3; a bi-convex fourth lens element L4; and a negative meniscus fifth lens element L5 with the convex surface facing the image side. The third lens element L3 has two aspheric surfaces.

The third lens unit G3 comprises solely a negative meniscus sixth lens element L6 with the convex surface facing the image side.

The fourth lens unit G4, in order from the object side to the image side, comprises: a bi-convex seventh lens element L7; a negative meniscus eighth lens element L8 with the convex surface facing the image side; an aperture diaphragm A; a bi-concave ninth lens element L9; a bi-convex tenth lens element L10; a bi-concave eleventh lens element L11; and a bi-convex twelfth lens element L12. The seventh lens element L7 and the eighth lens element L8 are cemented with each other. In the surface data of the corresponding Numerical Example described later, a surface number 14 is imparted to an adhesive layer between the seventh lens element L7 and the eighth lens element L8. In addition, the tenth lens element L10 and the eleventh lens element L11 are cemented with each other. In the surface data of the corresponding Numerical Example described later, a surface number 21 is imparted to an adhesive layer between the tenth lens element L10 and the eleventh lens element L11. The ninth lens element L9 has two aspheric surfaces, and the twelfth lens element L12 has two aspheric surfaces.

The fifth lens unit G5 comprises solely a negative meniscus thirteenth lens element L13 with the convex surface facing the object side.

The sixth lens unit G6, in order from the object side to the image side, comprises: a bi-convex fourteenth lens element L14; a bi-concave fifteenth lens element L15; a positive meniscus sixteenth lens element L16 with the convex surface facing the object side; and a negative meniscus seventeenth lens element L17 with the convex surface facing the image side. The fifteenth lens element L15 has two aspheric surfaces.

The seventh lens unit G7 comprises solely a positive meniscus eighteenth lens element L18 with the convex surface facing the image side.

In zooming from the wide-angle limit to the telephoto limit at the time of image taking, the respective lens units move along the optical axis such that the interval between the first lens unit G1 and the second lens unit G2 increases, the interval between the second lens unit G2 and the third lens unit G3 decreases, the interval between the third lens unit G3 and the fourth lens unit G4 decreases, the interval between the fourth lens unit G4 and the fifth lens unit G5 increases, the interval between the fifth lens unit G5 and the sixth lens unit G6 decreases, and the interval between the sixth lens unit G6 and the seventh lens unit G7 increases.

In focusing from the infinity in-focus condition to the close-object in-focus condition, the third lens unit G3 serving as a focusing lens unit moves to the object side along the optical axis, and the fifth lens unit G5 serving as another focusing lens unit moves to the image side along the optical axis.

The ninth lens element L9, which is a part of the fourth lens unit G4, corresponds to an image blur compensating lens unit that moves in a direction perpendicular to the optical axis to optically compensate image blur.

### Embodiment 6

The first lens unit G1 comprises solely a positive meniscus first lens element L1 with the convex surface facing the object side.

The second lens unit G2, in order from the object side to the image side, comprises: a negative meniscus second lens element L2 with the convex surface facing the object side; a bi-concave third lens element L3; and a bi-convex fourth lens element L4. The third lens element L3 has two aspheric surfaces.

The third lens unit G3 comprises solely a negative meniscus fifth lens element L5 with the convex surface facing the image side.

The fourth lens unit G4, in order from the object side to the image side, comprises: an aperture diaphragm A; a bi-convex sixth lens element L6; a bi-concave seventh lens element L7; a bi-convex eighth lens element L8; a bi-concave ninth lens element L9; and a positive meniscus tenth lens element L10 with the convex surface facing the object side. The eighth lens element L8 and the ninth lens element L9 are cemented with each other. In the surface data of the corresponding Numerical Example described later, a surface number 17 is imparted to an adhesive layer between the eighth lens element L8 and the ninth lens element L9. The seventh lens element L7 has two aspheric surfaces, and the tenth lens element L10 has two aspheric surfaces.

The fifth lens unit G5 comprises solely a negative meniscus eleventh lens element L11 with the convex surface facing the object side.

The sixth lens unit G6, in order from the object side to the image side, comprises: a bi-convex twelfth lens element L12; a bi-concave thirteenth lens element L13; and a negative meniscus fourteenth lens element L14 with the convex surface facing the image side. The thirteenth lens element L13 has two aspheric surfaces.

The seventh lens unit G7 comprises solely a positive meniscus fifteenth lens element L15 with the convex surface facing the image side.

In zooming from the wide-angle limit to the telephoto limit at the time of image taking, the respective lens units move along the optical axis such that the interval between the first lens unit G1 and the second lens unit G2 increases, the interval between the second lens unit G2 and the third lens unit G3 decreases, the interval between the third lens unit G3 and the fourth lens unit G4 decreases, the interval between the fourth lens unit G4 and the fifth lens unit G5 increases, the interval between the fifth lens unit G5 and the sixth lens unit G6 increases, and the interval between the sixth lens unit G6 and the seventh lens unit G7 increases.

In focusing from the infinity in-focus condition to the close-object in-focus condition, the third lens unit G3 serving as a focusing lens unit moves to the object side along the optical axis, and the fifth lens unit G5 serving as another focusing lens unit moves to the image side along the optical axis.

The seventh lens element L7, which is a part of the fourth lens unit G4, corresponds to an image blur compensating lens unit that moves in a direction perpendicular to the optical axis to optically compensate image blur.

As described above, each of the zoom lens systems according to Embodiments 1 to 6, in order from the object side to the image side, comprises the first lens unit G1 having positive optical power, the second lens unit G2 having negative optical power, and the subsequent lens units composed of three or more lens units and the aperture diaphragm A.

In the zoom lens systems according to Embodiments 1 to 6, the first lens unit G1 is composed of two or less lens elements including a lens element having positive optical power. Therefore, reduction in the overall length of the lens system is realized.

When the first lens unit G1 is composed of one lens element having positive optical power, the effect of reducing the overall length of the lens system can be further enhanced.

In the zoom lens systems according to Embodiments 1 to 6, the second lens unit G2, in order from the object side to the image side, includes: two lens elements having negative optical power; and one lens element having positive optical power. Therefore, curvature of field can be compensated for over the entire zooming range, resulting in improved optical performance.

In the zoom lens systems according to Embodiments 1 to 6, among the subsequent lens units, the lens unit located second from the object side, i.e., the fourth lens unit G4, includes the aperture diaphragm A, and the fourth lens unit G4 includes two or more bi-convex lens elements. Therefore, spherical aberration can be effectively compensated in the vicinity of the aperture diaphragm A where an axial light beam spreads.

In the zoom lens systems according to Embodiments 1 to 6, in zooming from the wide-angle limit to the telephoto limit at the time of image taking, the respective lens units move to the object side along the optical axis such that the interval between the first lens unit G1 and the second lens unit G2 at the telephoto limit is longer than that at the wide-angle limit, and the interval between the second lens unit G2 and the third lens unit G3 at the telephoto limit is shorter than that at the wide-angle limit. That is, all the lens units, which move along the optical axis in zooming, move such that their positions at the telephoto limit are on the object side with respect to the image surface, relative to the positions at the wide-angle limit. In zooming, the aperture diaphragm A moves along the optical axis together with the fourth lens unit G4.

In the zoom lens systems according to Embodiments 1 to 6, three or more lens elements having negative optical power are located between the first lens unit G1 and the aperture diaphragm A.

In a case of a large-diameter zoom lens system, generally, an aperture diaphragm A needs to be opened wider at the telephoto limit than at the wide-angle limit, in order to ensure, at the telephoto limit, the same brightness as that at the wide-angle limit. As a result, many spherical aberrations occur at the telephoto limit, which adversely affect optical performance. However, by locating three or more lens elements having negative optical power between the first lens unit G1 and the aperture diaphragm A, the spherical aberrations that occur at the telephoto limit can be sufficiently compensated.

In the zoom lens systems according to Embodiments 1 to 6, in zooming from the wide-angle limit to the telephoto limit at the time of image taking, the first lens unit G1 moves along the optical axis. Therefore, the heights of light beams of the lens units located on the image side relative to the first lens unit G1 can be reduced. As a result, reduction in the diameters of the lens units located on the image side relative to the first lens unit G1 can be realized, and furthermore, reduction in diameter and weight of a focusing lens unit can also be realized in an optical system adopting an inner focus method.

In the zoom lens systems according to Embodiments 1 to 6, in zooming from the wide-angle limit to the telephoto limit at the time of image taking, the second lens unit G2 moves along the optical axis. Therefore, curvature of field can be compensated over the entire zooming range, resulting in improved imaging performance.

In the zoom lens systems according to Embodiments 1 to 6, in zooming from the wide-angle limit to the telephoto limit at the time of image taking, the third lens unit G3 moves along the optical axis. Therefore, imaging performance can be improved while achieving size reduction of the zoom lens system.

Each of the zoom lens systems according to Embodiments 1 to 6 includes an image blur compensating lens unit which is composed of one or more lens elements and moves in the direction perpendicular to the optical axis in order to compensate image point movement caused by vibration of the entire system, that is, optically compensate image blur caused by hand blurring, vibration and the like. Further, each of the zoom lens systems according to Embodiments 1 to 6 includes one or more focusing lens units each composed of one or more lens elements, which move along the optical axis in focusing from the infinity in-focus condition to the close-object in-focus condition.

In the zoom lens systems according to Embodiments 1 to 6, any lens unit or a part of any lens unit among the subsequent lens units is an image blur compensating lens unit, and the image blur compensating lens unit is located on the image side relative to the aperture diaphragm A. Therefore, reduction in lens diameter of the image blur compensating lens unit can be realized.

In the zoom lens systems according to Embodiments 1 to 6, the image blur compensating lens unit is composed of one lens element. Therefore, weight reduction of the image blur compensating lens unit is realized, which makes it possible to simplify the configuration of the image blur compensation mechanism. As a result, size reduction of a lens barrel is realized.

Furthermore, by locating one or more lens units having positive optical power on the image side relative to the image blur compensating lens unit, optical performance during image blur compensation can be maintained more satisfactorily.

In the zoom lens systems according to Embodiments 1 to 6, the focusing lens unit that moves along the optical axis in focusing from the infinity in-focus condition to the close-object in-focus condition is composed of two or less lens elements. Therefore, weight reduction of the focusing lens unit is realized.

Furthermore, it is beneficial that the focusing lens unit is composed of only a single lens element. In this case, high-speed response in focusing due to the lightweight focusing lens unit can be expected.

In the zoom lens systems according to Embodiments 1 to 3, 5, and 6, among the subsequent lens units, the lens unit located closest to the object side, i.e., the third lens unit G3, is a focusing lens unit that moves along the optical axis in focusing from the infinity in-focus condition to the close-object in-focus condition.

In the zoom lens systems according to Embodiments 1, 2, and 4 to 6, among the subsequent lens units, the lens unit located on the image side relative to the aperture diaphragm A is the focusing lens unit.

In the zoom lens systems according to Embodiments 1, 2, 5, and 6, among the subsequent lens units, two or more lens units are focusing lens units. Therefore, optical performance in the close-object in-focus condition can be satisfactorily maintained.

In the zoom lens systems according to Embodiments 1 to 6, among the subsequent lens units, the lens element located closest to the image side has positive optical power. Therefore, the incident angle of a light beam that enters an image sensor located at the image surface S can be made gentle.

The following description is given for conditions that a zoom lens system like the zoom lens systems according to Embodiments 1 to 6 can satisfy. Here, a plurality of beneficial conditions is set forth for the zoom lens system according to each embodiment. A construction that satisfies all the plurality of conditions is most effective for the zoom lens system. However, when an individual condition is satisfied, a zoom lens system having the corresponding effect is obtained.

For example, in a zoom lens system like the zoom lens systems according to Embodiments 1 to 6, which comprises, in order from the object side to the image side, a first lens unit having positive optical power, a second lens unit having negative optical power, and subsequent lens units composed of three or more lens units and an aperture diaphragm, in which the intervals between the adjacent lens units vary in zooming from the wide-angle limit to the telephoto limit at the time of image taking, the first lens unit is composed of two or less lens elements and moves along the optical axis in the zooming, and three or more lens elements having negative optical power are located between the first lens unit and the aperture diaphragm (this lens configuration is referred to as a basic configuration of the embodiments, hereinafter), the following conditions (1) and (2) are satisfied:

0.30<|BF_{W}/Y_{W}|<1.39 (1)

1.10<SD_{T}/SD_{W}<2.00 (2)

where

BF_{W} is a back focal length at the wide-angle limit,

Y_{W} is a diagonal image height at the wide-angle limit, expressed by the following formula:

Y_{W}=f_{W}×tan(ω_{W}),

f_{W} is a focal length of the zoom lens system at the wide-angle limit,

ω_{W} is a half view angle at the wide-angle limit,

SD_{W} is a maximum diameter of the aperture diaphragm at the wide-angle limit, and

SD_{T} is a maximum diameter of the aperture diaphragm at the telephoto limit.

The condition (1) sets forth the ratio between the back focal length at the wide-angle limit, i.e., a distance from an apex of an image side surface of a lens element located closest to the image side to the image surface, and the diagonal image height at the wide-angle limit. Since the zoom lens systems according to Embodiments 1 to 6 satisfy the condition (1), reduction in the overall length of the lens system is realized while satisfactorily maintaining optical performance.

When the value exceeds the upper limit of the condition (1), the back focal length is lengthened with respect to the diagonal image height at the wide-angle limit, and thereby the incident angle of the light beam that enters the image sensor becomes gentle. However, the overall length of the lens system is increased, which makes it difficult to achieve size reduction of the zoom lens system. When the value goes below the lower limit of the condition (1), inclination of the incident angle of the light beam that enters the image sensor is increased, which makes it difficult to maintain high optical performance.

When at least one of the following conditions (1)′ and (1)″ is satisfied, the above-mentioned effect is achieved more successfully.

0.45<|BF_{W}/Y_{W}| (1)′

|BF_{W}/Y_{W}|<1.30 (1)″

The condition (2) sets forth the ratio between the maximum diameter of the aperture diaphragm at the telephoto limit and the maximum diameter of the aperture diaphragm at the wide-angle limit. Since the zoom lens systems according to Embodiments 1 to 6 satisfy the condition (2), image taking with uniform condition of brightness is achieved in zooming from the wide-angle limit to the telephoto limit

When the value exceeds the upper limit of the condition (2), many spherical aberrations and coma aberrations occur at the telephoto limit in association with increase in the diameter, which causes a significant difference between the optical performance at the telephoto limit and that at the wide-angle limit. When the value goes below the lower limit of the condition (2), a difference between the amount of light at the wide-angle limit and that at the telephoto limit is increased, which is inappropriate for image taking with the uniform condition of brightness in zooming from the wide-angle limit to the telephoto limit.

When at least one of the following conditions (2-1)′ and (2-1)″ is satisfied, the above-mentioned effect is achieved more successfully.

1.20<SD_{T}/SD_{W} (2-1)′

SD_{T}/SD_{W}<1.80 (2-1)″

When at least one of the following conditions (2-2)′ and (2-2)″ is further satisfied, the above-mentioned effect is achieved more successfully.

1.30<SD_{T}/SD_{W} (2-2)′

SD_{T}/SD_{W}<1.70 (2-2)″

The individual lens units constituting the zoom lens systems according to Embodiments 1 to 6 are each composed exclusively of refractive type lens elements that deflect incident light by refraction (that is, lens elements of a type in which deflection is achieved at the interface between media having different refractive indices). However, the present disclosure is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved. Thus, such a configuration is beneficial.

As described above, Embodiments 1 to 6 have been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

### Embodiment 7

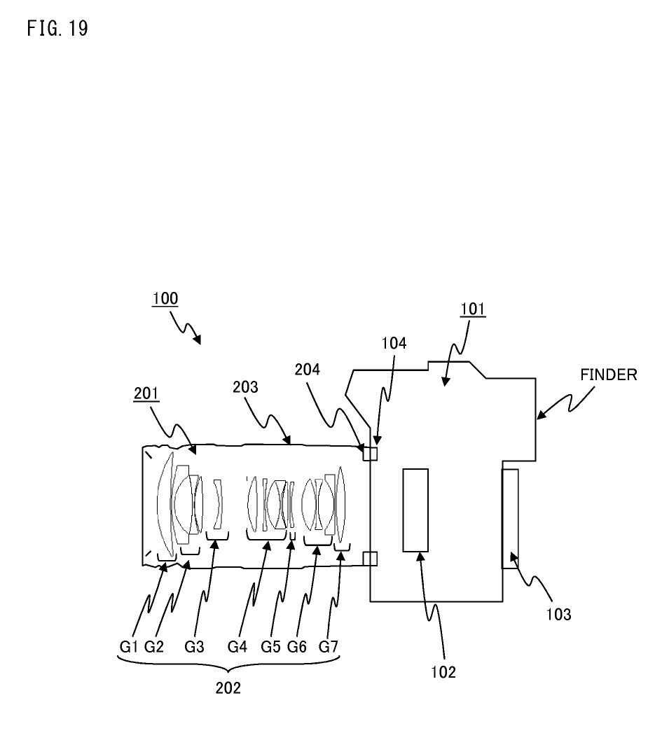

FIG. 19 is a schematic construction diagram of an interchangeable-lens type digital camera system according to Embodiment 7.

The interchangeable-lens type digital camera system 100 according to Embodiment 7 includes a camera body 101, and an interchangeable lens apparatus 201 which is detachably connected to the camera body 101.

The camera body 101 includes: an image sensor 102 which receives an optical image formed by a zoom lens system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a zoom lens system 202 according to any of Embodiments 1 to 6; a lens barrel 203 which holds the zoom lens system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201. In FIG. 19, the zoom lens system according to Embodiment 1 is employed as the zoom lens system 202.

In Embodiment 7, since the zoom lens system 202 according to any of Embodiments 1 to 6 is employed, a compact interchangeable lens apparatus having excellent imaging performance can be realized at low cost. Moreover, size reduction and cost reduction of the entire camera system 100 according to Embodiment 7 can be achieved. In the zoom lens systems according to Embodiments 1 to 6, the entire zooming range need not be used. That is, in accordance with a desired zooming range, a range where satisfactory optical performance is obtained may exclusively be used. Then, the zoom lens system may be used as one having a lower magnification than the zoom lens systems described in Embodiments 1 to 6.

As described above, Embodiment 7 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

Numerical examples are described below in which the zoom lens systems according to Embodiments 1 to 6 are implemented. Here, in the numerical examples, the units of length are all “mm”, while the units of view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspherical surfaces, and the aspherical surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is a n-th order aspherical coefficient.

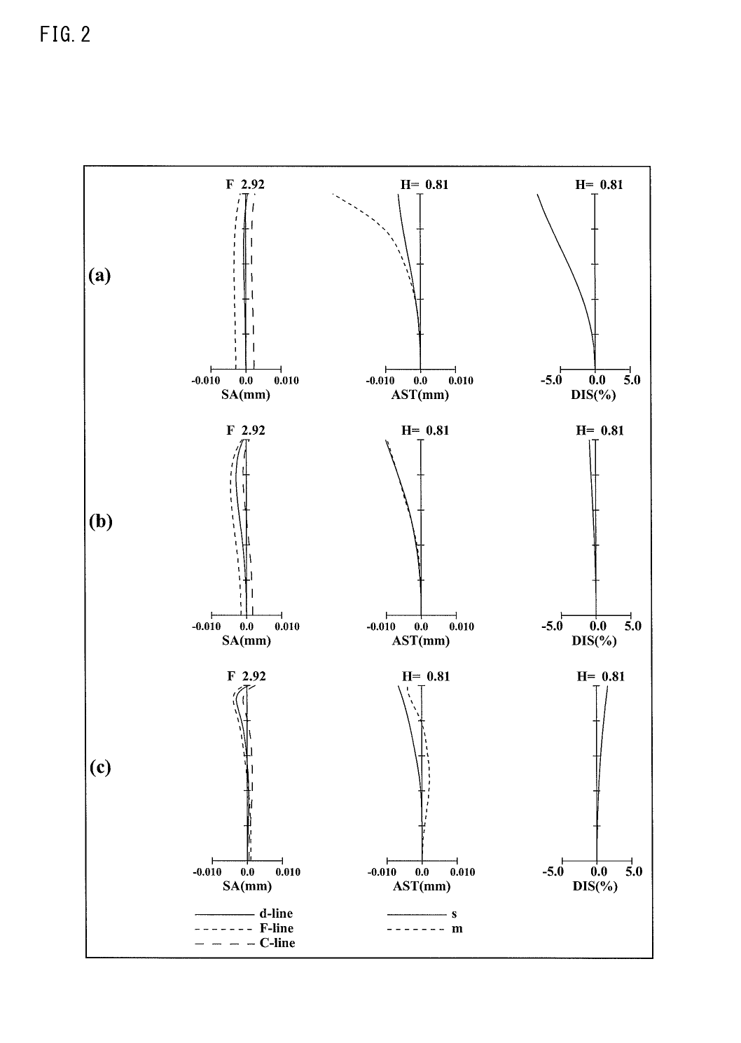

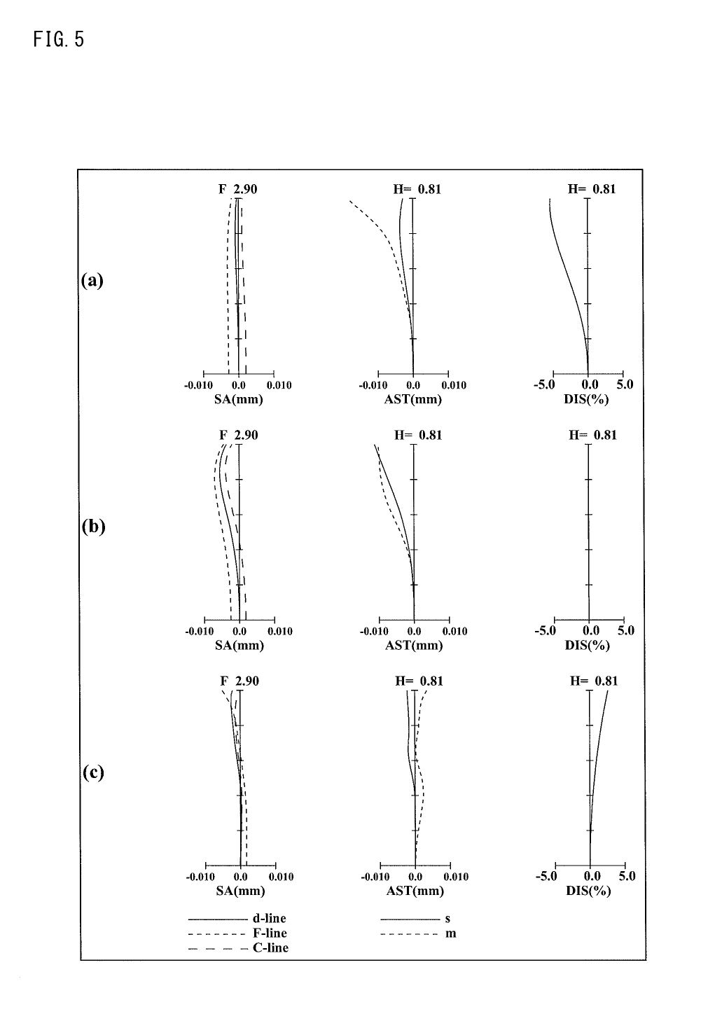

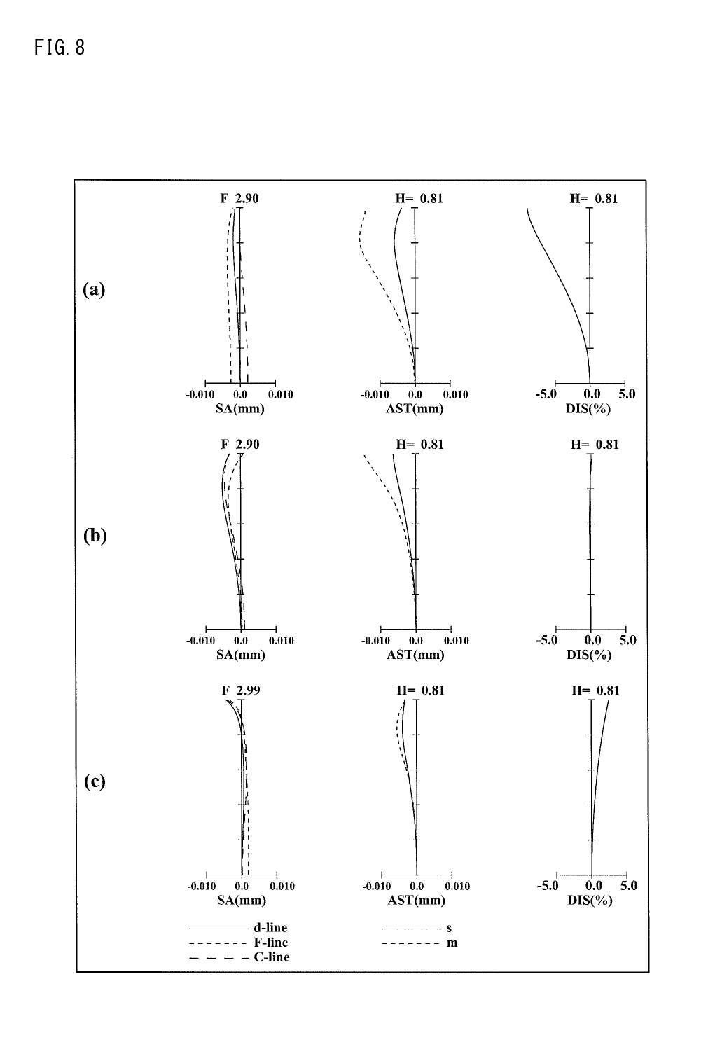

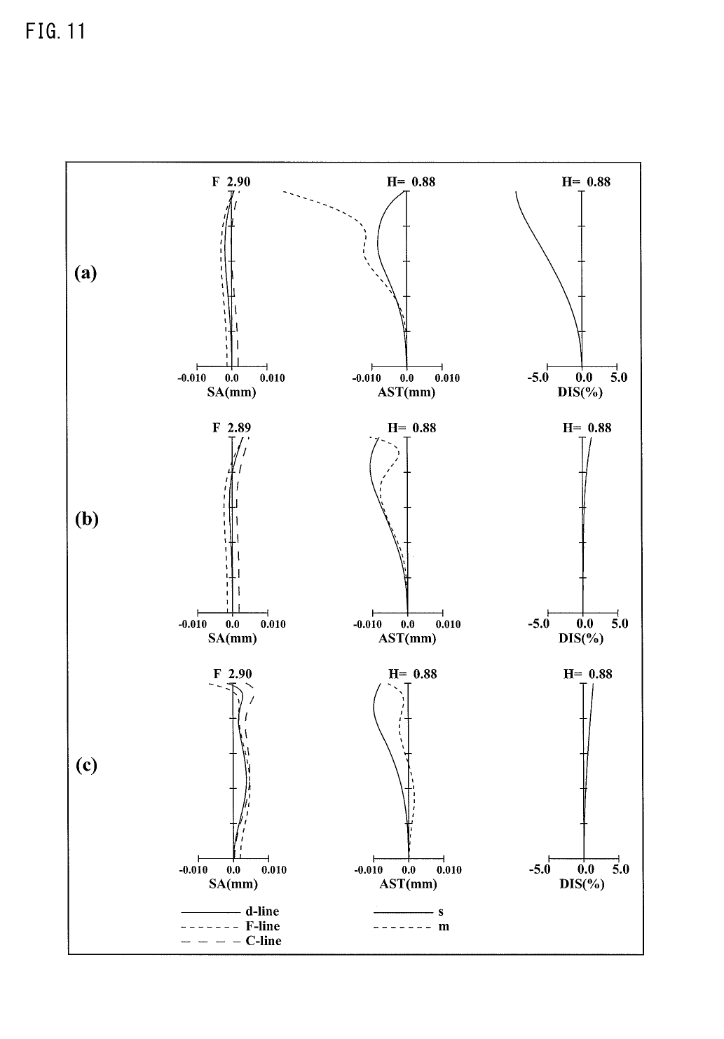

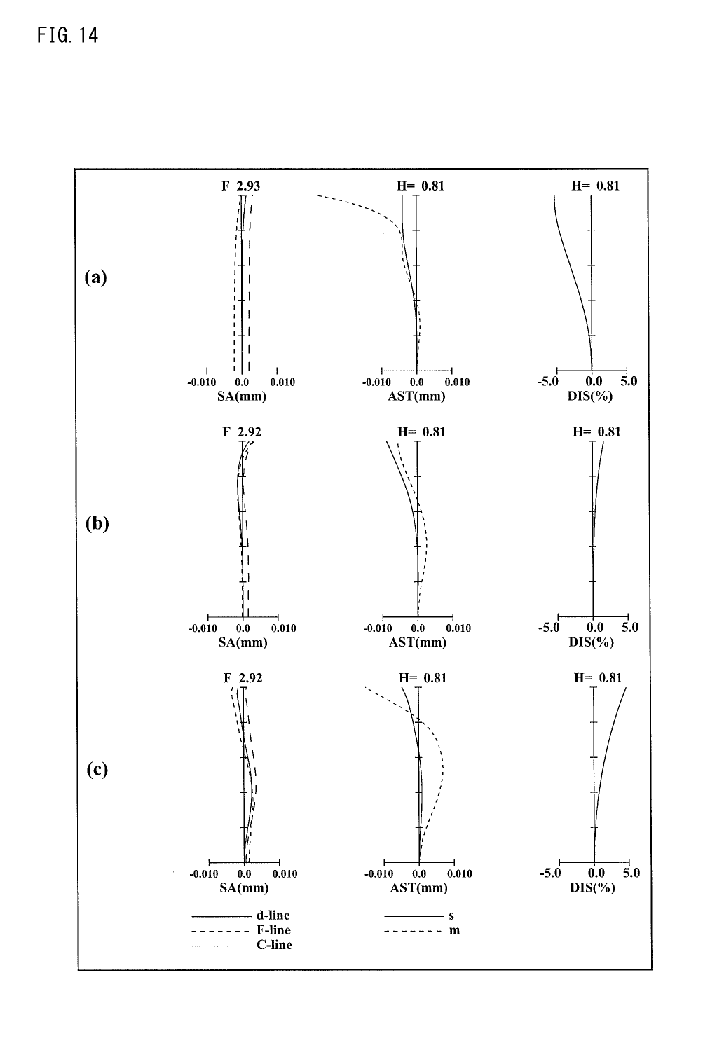

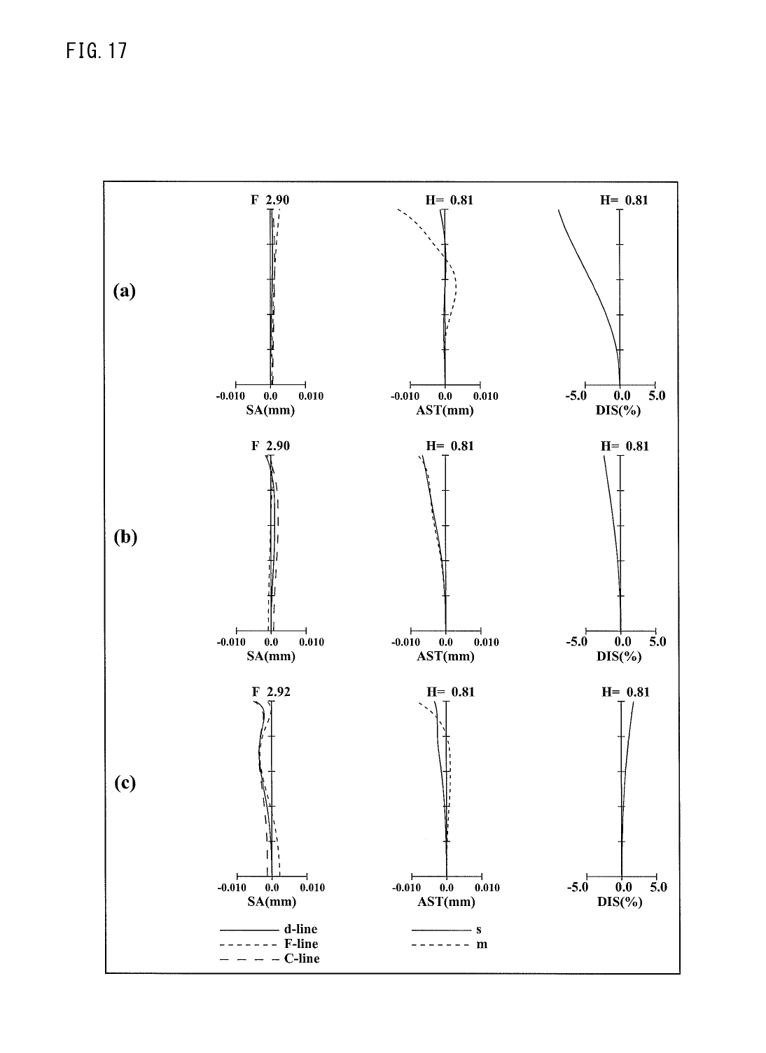

FIGS. 2, 5, 8, 11, 14, and 17 are longitudinal aberration diagrams of an infinity in-focus condition of the zoom lens systems according to Numerical Examples 1 to 6, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

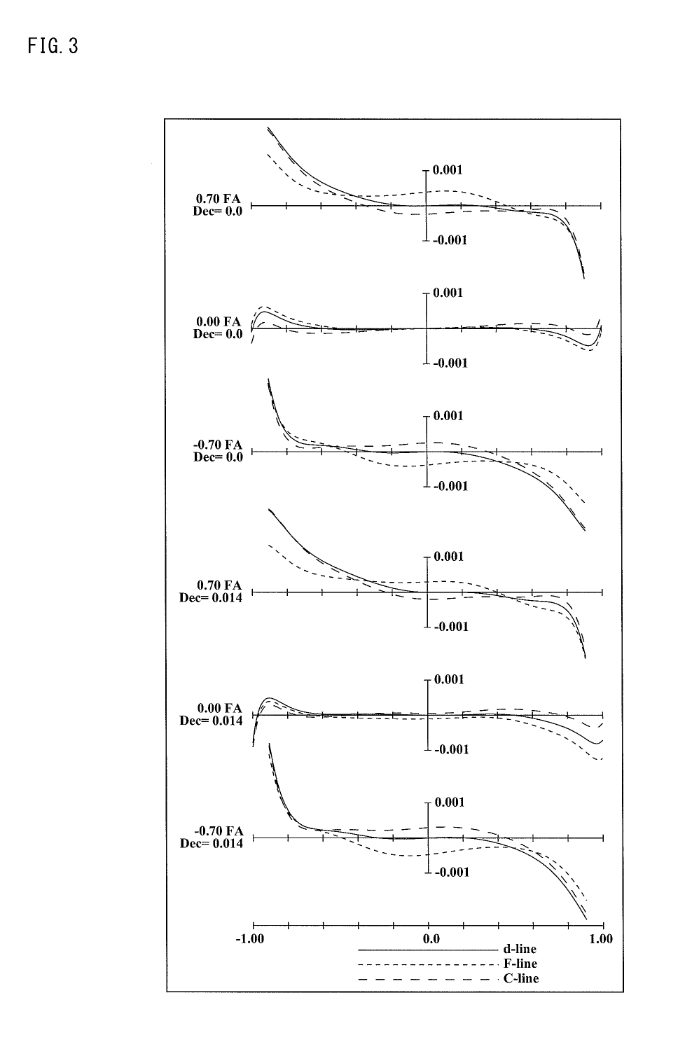

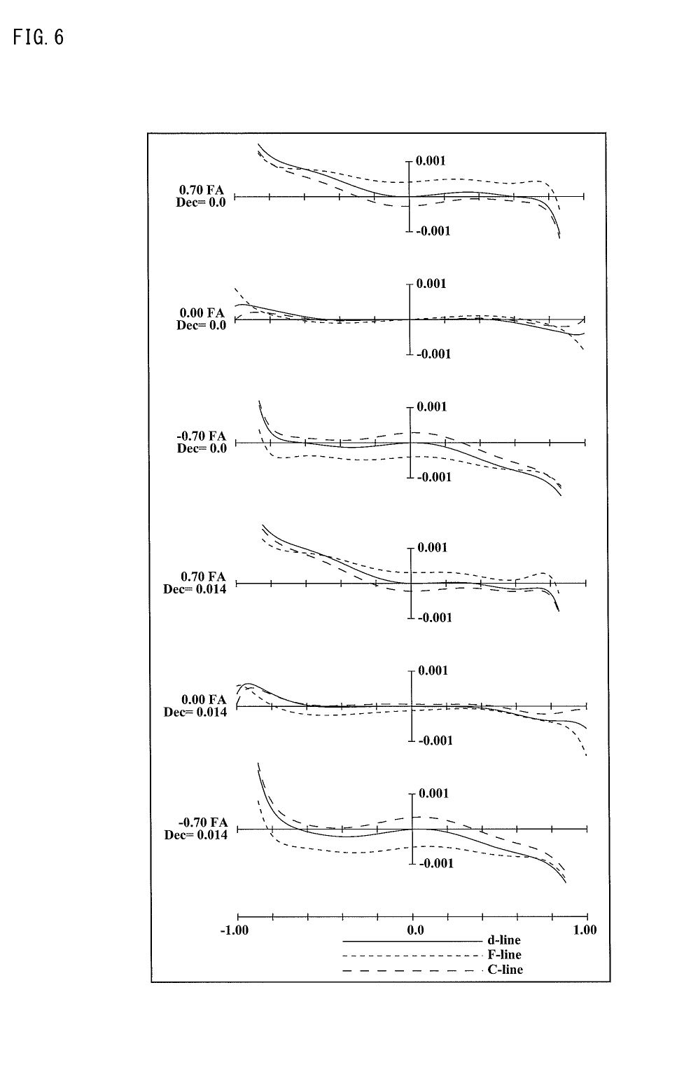

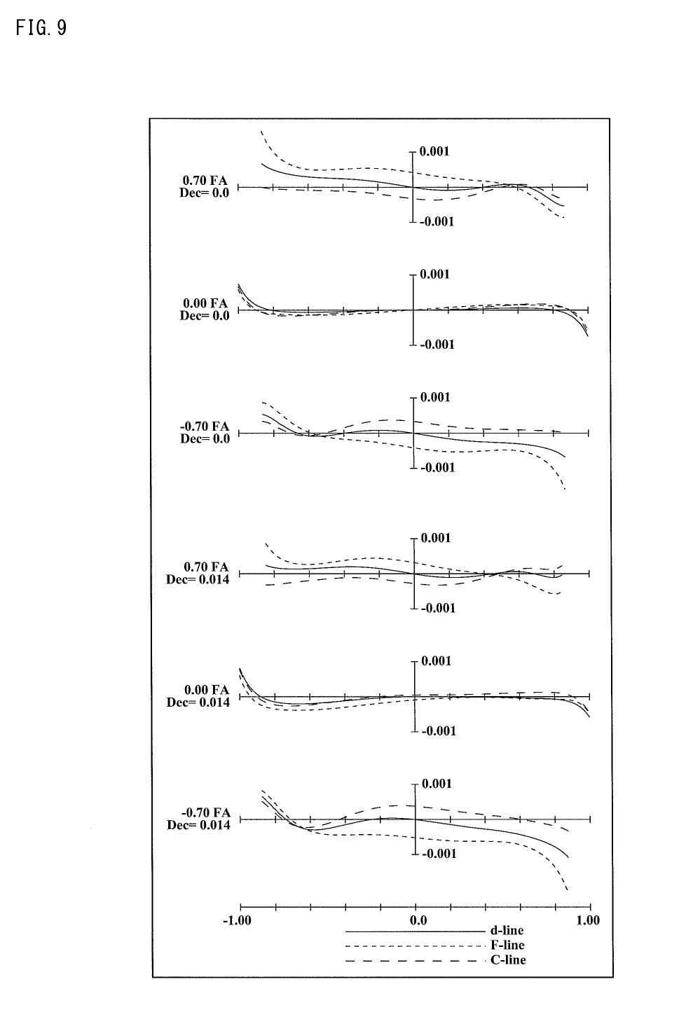

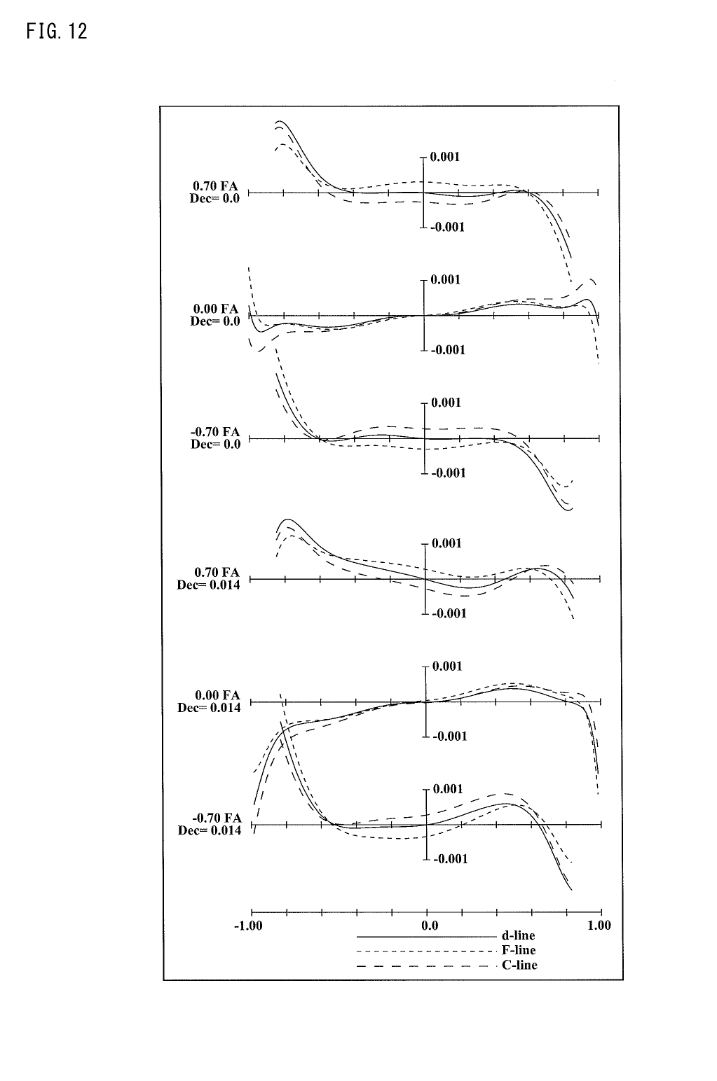

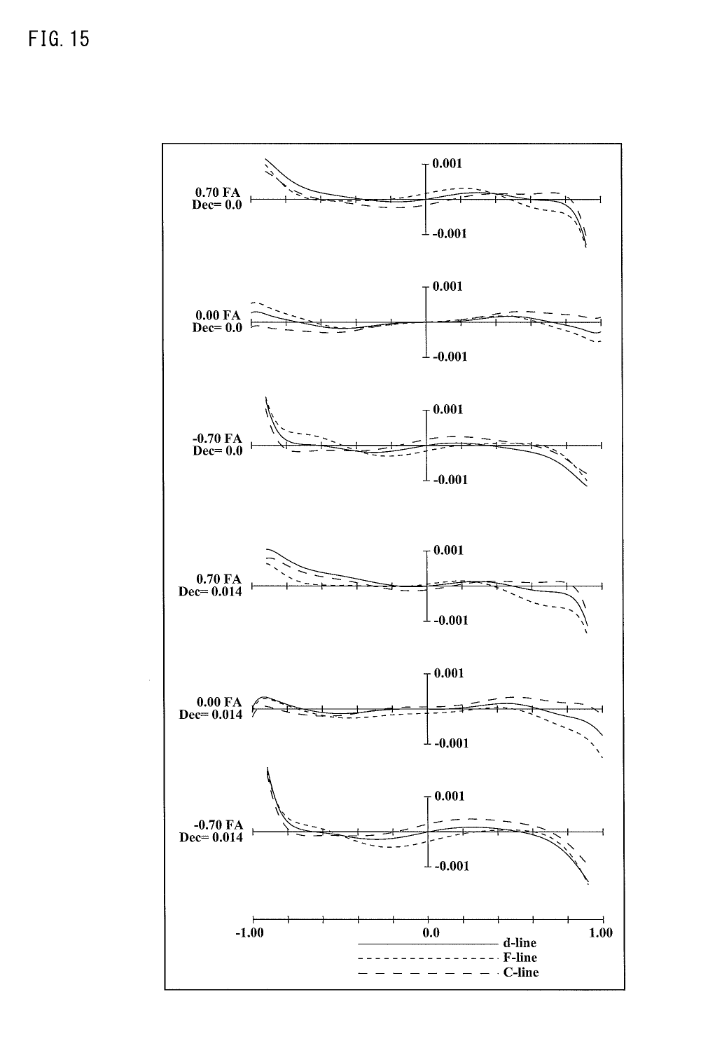

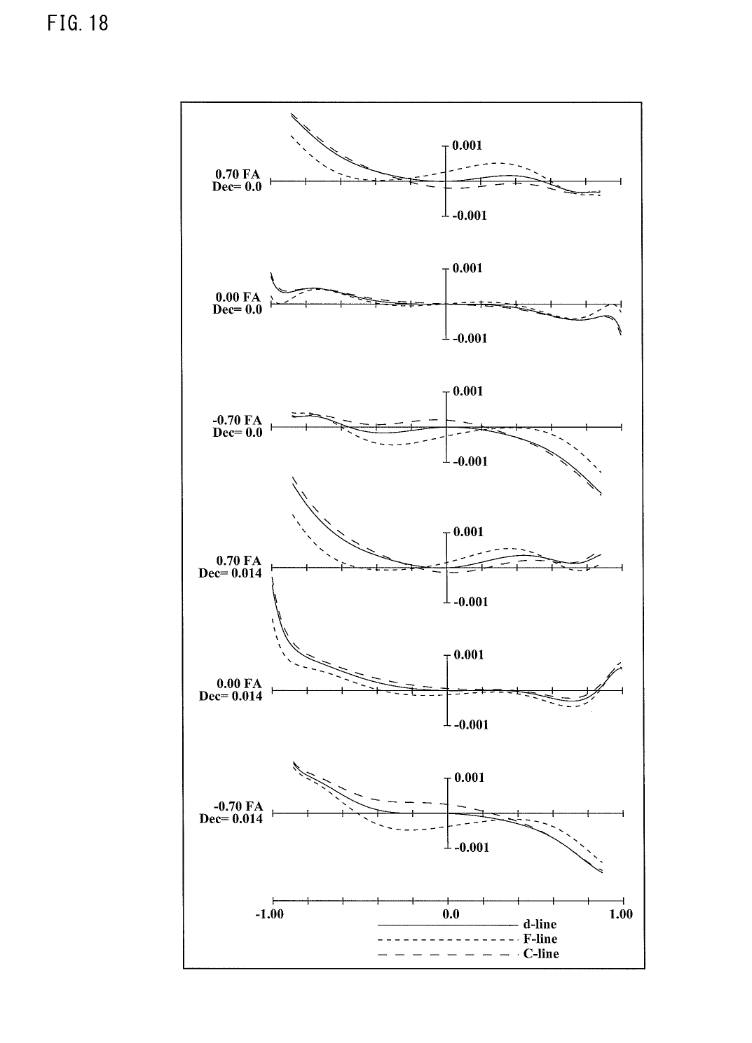

FIGS. 3, 6, 9, 12, 15, and 18 are lateral aberration diagrams of the zoom lens systems at a telephoto limit according to Numerical Examples 1 to 6, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the image blur compensating lens unit is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line, and the long dash line indicate the characteristics to the d-line, the F-line, and the C-line, respectively. In each lateral aberration diagram, the meridional plane is adopted as the plane containing the optical axis of the first lens unit G1.

Here, in the zoom lens system according to each example, the amount of movement of the image blur compensating lens unit in a direction perpendicular to the optical axis in an image blur compensation state at a telephoto limit is as follows.

| Numerical Example | Amount of movement (mm) |
|---|---|
| 1 | 0.014 |
| 2 | 0.014 |
| 3 | 0.014 |
| 4 | 0.014 |
| 5 | 0.014 |
| 6 | 0.014 |

When the shooting distance is infinity, at a telephoto limit, the amount of image decentering in a case that the zoom lens system inclines by 0.3° is equal to the amount of image decentering in a case that the image blur compensating lens unit displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.3° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data. Table 4 shows the single lens data. Table 5 shows the zoom lens unit data. Table 6 shows the magnification of zoom lens unit.

TABLE 1
(Surface data)

| Surface number | r | d | nd | vd |
|---|---|---|---|---|
| Object surface | ∞ | | | |
| 1 | 2.08010 | 0.29530 | 1.59349 | 67.0 |
| 2 | 10.38890 | Variable | | |
| 3 | 3.02610 | 0.05660 | 2.00069 | 25.5 |
| 4 | 0.78610 | 0.33790 | | |
| 5* | −2.80650 | 0.04450 | 1.61881 | 63.9 |
| 6* | 2.11510 | 0.00430 | | |
| 7 | 1.52320 | 0.16950 | 1.92049 | 20.4 |
| 8 | −3.44070 | 0.03350 | | |
| 9 | −1.89360 | 0.03010 | 1.93985 | 31.6 |
| 10 | −2.43920 | Variable | | |
| 11 | −1.08360 | 0.03640 | 1.71300 | 53.9 |
| 12 | −4.95280 | Variable | | |
| 13 | 1.24260 | 0.19590 | 1.95375 | 32.3 |
| 14 | −5.24890 | 0.00040 | 1.56732 | 42.8 |
| 15 | −5.24890 | 0.02830 | 1.91285 | 18.6 |
| 16 | −5.77800 | 0.04050 | | |
| 17(Diaphragm) | ∞ | 0.08320 | | |
| 18* | −5.77460 | 0.02830 | 1.77250 | 49.5 |
| 19* | 3.62930 | 0.04050 | | |
| 20 | 0.86250 | 0.27560 | 1.61800 | 63.4 |
| 21 | −1.31230 | 0.00040 | 1.56732 | 42.8 |
| 22 | −1.31230 | 0.02830 | 1.93194 | 23.1 |
| 23 | 1.12040 | 0.02820 | | |
| 24* | 1.12950 | 0.11290 | 1.85135 | 40.1 |
| 25* | −139.70570 | Variable | | |
| 26 | 5.47530 | 0.02830 | 1.80518 | 25.5 |
| 27 | 1.53880 | Variable | | |
| 28 | 0.95210 | 0.34050 | 1.59282 | 68.6 |
| 29 | −1.40710 | 0.02080 | | |
| 30* | −16.27190 | 0.02930 | 1.76801 | 49.2 |
| 31* | 1.52520 | 0.07240 | | |
| 32 | 3.72460 | 0.05730 | 1.70656 | 25.4 |
| 33 | 7.11800 | 0.19660 | | |
| 34 | −0.77810 | 0.02830 | 1.62217 | 62.7 |
| 35 | −21.44740 | Variable | | |
| 36 | 5.15790 | 0.16480 | 1.94595 | 18.0 |
| 37 | −3.36610 | (BF) | | |
| Image surface | ∞ | | | |

TABLE 2
(Aspherical data)

Surface No. 5
K = 0.00000E+00, A4 = 1.99113E−02, A6 = 3.67766E−02,
A8 = 1.45427E−01 A10 = −2.90987E−01
Surface No. 6
K = 0.00000E+00, A4 = −7.04614E−02, A6 = −4.00806E−03,
A8 = −7.44474E−02 A10 = −3.28602E−01
Surface No. 18
K = 0.00000E+00, A4 = 2.20636E−02, A6 = −1.98617E−02,
A8 = 9.51305E−02 A10 = −5.27705E−01
Surface No. 19
K = 0.00000E+00, A4 = −1.99548E−02, A6 = 5.35999E−02,
A8 = −2.02944E−01 A10 = −2.72783E−01
Surface No. 24
K = 0.00000E+00, A4 = −3.89066E−01, A6 = −9.49243E−02,
A8 = −8.66886E−01 A10 = 1.87708E+00
Surface No. 25
K = 0.00000E+00, A4 = 5.93174E−02, A6 = −2.15146E−01,
A8 = 2.50322E−01 A10 = −1.04512E−03
Surface No. 30
K = 0.00000E+00, A4 = −2.09188E−01, A6 = −2.15261E−01,
A8 = 5.66262E−02 A10 = −3.91742E+00
Surface No. 31
K = 0.00000E+00, A4 = 1.89495E−01, A6 = 2.03738E−02,
A8 = 2.29840E+00 A10 = −8.10091E+00

TABLE 3
(Various data)
Zooming ratio 2.74588

| | Wide-angle | Middle | Telephoto |
|---|---|---|---|
| | limit | position | limit |
| Focal length | 0.9999 | 1.6569 | 2.7455 |
| F-number | 2.92252 | 2.92090 | 2.92378 |
| Half view angle | 41.4050 | 26.2253 | 16.1714 |
| Image height | 0.8090 | 0.8090 | 0.8090 |
| Overall length | 4.4370 | 4.7915 | 5.8229 |
| of lens system | | | |
| BF | 0.48280 | 0.89769 | 1.15552 |
| d2 | 0.0202 | 0.3185 | 1.0025 |
| d10 | 0.2496 | 0.2528 | 0.2950 |
| d12 | 0.5669 | 0.2340 | 0.0663 |
| d25 | 0.0417 | 0.0861 | 0.0599 |
| d27 | 0.2467 | 0.0871 | 0.0557 |
| d35 | 0.0202 | 0.1064 | 0.3791 |
| Entrance pupil | 1.1177 | 1.5373 | 3.0905 |
| position | | | |
| Exit pupil | −1.7741 | −2.2368 | −3.2710 |
| position | | | |
| Front principal | 1.5535 | 1.9672 | 3.5306 |
| points position | | | |
| Back principal | 3.4371 | 3.1346 | 3.0774 |
| points position | | | |

TABLE 4
(Single lens data)

| Lens | Initial surface | Focal |
|---|---|---|
| element | number | length |
| 1 | 1 | 4.3250 |
| 2 | 3 | −1.0748 |
| 3 | 5 | −1.9424 |
| 4 | 7 | 1.1661 |
| 5 | 9 | −9.2548 |
| 6 | 11 | −1.9530 |
| 7 | 13 | 1.0692 |
| 8 | 15 | −64.4375 |
| 9 | 18 | −2.8812 |
| 10 | 20 | 0.8850 |
| 11 | 22 | −0.6449 |
| 12 | 24 | 1.3166 |
| 13 | 26 | −2.6667 |
| 14 | 28 | 1.0123 |
| 15 | 30 | −1.8144 |
| 16 | 32 | 10.9806 |
| 17 | 34 | −1.2984 |
| 18 | 36 | 2.1737 |

TABLE 5
(Zoom lens unit data)

| | Initial | | Overall | Front princi- | Back princi- |
|---|---|---|---|---|---|
| Lens | surface | Focal | length of | pal points | pal points |
| unit | No. | length | lens unit | position | position |
| 1 | 1 | 4.32503 | 0.29530 | −0.04579 | 0.06662 |
| 2 | 3 | −1.75466 | 0.67640 | −0.16381 | −0.10835 |
| 3 | 11 | −1.95305 | 0.03640 | −0.00597 | 0.00909 |
| 4 | 13 | 0.99667 | 0.86250 | 0.03605 | 0.32659 |
| 5 | 26 | −2.66674 | 0.02830 | 0.02188 | 0.03445 |
| 6 | 28 | 9.79946 | 0.74520 | −4.39438 | −2.69104 |
| 7 | 36 | 2.17366 | 0.16480 | 0.05173 | 0.13104 |

TABLE 6
(Magnification of zoom lens unit)

| Lens | Initial | Wide-angle | Middle | Telephoto |
|---|---|---|---|---|
| unit | surface No. | limit | position | limit |
| 1 | 1 | 0.00000 | 0.00000 | 0.00000 |
| 2 | 3 | −0.70602 | −0.80231 | −1.16744 |
| 3 | 11 | 0.32688 | 0.31772 | 0.28595 |
| 4 | 13 | −1.05108 | −1.57399 | −1.88922 |
| 5 | 26 | 2.18233 | 3.57852 | 6.58747 |
| 6 | 28 | 0.57286 | 0.46688 | 0.33739 |
| 7 | 36 | 0.76236 | 0.57148 | 0.45287 |

### Numerical Example 2

The zoom lens system of Numerical Example 2 corresponds to Embodiment 2 shown in FIG. 4. Table 7 shows the surface data of the zoom lens system of Numerical Example 2. Table 8 shows the aspherical data. Table 9 shows the various data. Table 10 shows the single lens data. Table 11 shows the zoom lens unit data. Table 12 shows the magnification of zoom lens unit.

TABLE 7
(Surface data)

| Surface number | r | d | nd | vd |
|---|---|---|---|---|
| Object surface | ∞ | | | |
| 1 | 2.01140 | 0.28310 | 1.59201 | 67.0 |
| 2 | 10.66470 | Variable | | |
| 3 | 2.73270 | 0.05660 | 2.00069 | 25.5 |
| 4 | 0.76300 | 0.37190 | | |
| 5* | −2.95210 | 0.04450 | 1.61881 | 63.9 |
| 6* | 1.94180 | 0.00400 | | |
| 7 | 1.44430 | 0.16670 | 1.92286 | 20.9 |
| 8 | −6.58280 | Variable | | |
| 9 | −1.08290 | 0.05660 | 1.71300 | 53.9 |
| 10 | −5.05690 | Variable | | |
| 11(Diaphragm) | ∞ | 0.02430 | | |
| 12 | 1.21810 | 0.18570 | 1.95375 | 32.3 |
| 13 | −6.11440 | 0.14290 | | |
| 14* | −6.08100 | 0.02830 | 1.75039 | 45.5 |
| 15* | 3.42180 | 0.04040 | | |
| 16 | 0.85060 | 0.26610 | 1.61800 | 63.4 |
| 17 | −1.31580 | 0.00040 | 1.56732 | 42.8 |
| 18 | −1.31580 | 0.02840 | 1.93136 | 21.8 |
| 19 | 1.15990 | 0.02740 | | |
| 20* | 1.26140 | 0.11010 | 1.84434 | 32.8 |
| 21* | −9.43860 | Variable | | |
| 22 | 7.84100 | 0.02830 | 1.80448 | 28.0 |
| 23 | 1.50530 | Variable | | |
| 24 | 0.94160 | 0.29010 | 1.59282 | 68.6 |
| 25 | −1.30340 | 0.02270 | | |
| 26* | −13.20090 | 0.02850 | 1.75512 | 45.6 |
| 27* | 1.55780 | 0.32690 | | |
| 28 | −0.81950 | 0.02830 | 1.62185 | 62.8 |
| 29 | −427.39830 | Variable | | |
| 30 | 4.12120 | 0.18560 | 1.94595 | 18.0 |
| 31 | −3.52280 | (BF) | | |
| Image surface | ∞ | | | |

TABLE 8
(Aspherical data)

Surface No. 5
K = 0.00000E+00, A4 = 1.30353E−02, A6 = 2.74843E−02,
A8 = 1.78636E−01 A10 = −6.25695E−01
Surface No. 6
K = 0.00000E+00, A4 = −5.91672E−02, A6 = 4.55126E−02,
A8 = −5.25365E−02 A10 = −6.27117E−01
Surface No. 14
K = 0.00000E+00, A4 = 1.96831E−02, A6 = 1.81108E−03,
A8 = 1.13946E−01 A10 = −4.69434E−01
Surface No. 15
K = 0.00000E+00, A4 = −1.55157E−02, A6 = 4.05881E−02,
A8 = −1.85673E−01 A10 = −7.69621E−02
Surface No. 20
K = 0.00000E+00, A4 = −4.07338E−01, A6 = −1.35689E−01,
A8 = −9.88237E−01 A10 = 2.38053E+00
Surface No. 21
K = 0.00000E+00, A4 = 6.57462E−02, A6 = −1.73032E−01,
A8 = 4.45039E−01 A10 = −2.06507E−01
Surface No. 26
K = 0.00000E+00, A4 = −2.24771E−01, A6 = −3.04262E−01,
A8 = −5.10086E−01 A10 = −4.44251E+00
Surface No. 27
K = 0.00000E+00, A4 = 2.20376E−01, A6 = −4.02583E−02,
A8 = 1.93266E+00 A10 = −8.82096E+00

TABLE 9
(Various data)
Zooming ratio 2.74621

| | Wide-angle | Middle | Telephoto |
|---|---|---|---|
| | limit | position | limit |
| Focal length | 0.9998 | 1.6570 | 2.7457 |
| F-number | 2.90317 | 2.90253 | 2.89764 |
| Half view angle | 40.5303 | 26.0227 | 16.0223 |
| Image height | 0.8090 | 0.8090 | 0.8090 |
| Overall length | 4.3904 | 4.6156 | 5.6310 |
| of lens system | | | |
| BF | 0.48591 | 0.89635 | 1.05888 |
| d2 | 0.0201 | 0.3242 | 1.0290 |
| d8 | 0.3394 | 0.2498 | 0.2837 |
| d10 | 0.5198 | 0.1908 | 0.0404 |
| d21 | 0.0405 | 0.1155 | 0.0850 |
| d23 | 0.2167 | 0.0871 | 0.0700 |
| d29 | 0.0202 | 0.0040 | 0.3162 |
| Entrance pupil | 1.0936 | 1.4478 | 3.0389 |
| position | | | |
| Exit pupil | −1.9326 | −2.1813 | −3.3408 |
| position | | | |
| Front principal | 1.5760 | 1.8458 | 3.5276 |
| points position | | | |
| Back principal | 3.3906 | 2.9586 | 2.8852 |
| points position | | | |

TABLE 10
(Single lens data)

| Lens | Initial surface | Focal |
|---|---|---|
| element | number | length |
| 1 | 1 | 4.1370 |
| 2 | 3 | −1.0733 |
| 3 | 5 | −1.8863 |
| 4 | 7 | 1.2964 |
| 5 | 9 | −1.9442 |
| 6 | 12 | 1.0783 |
| 7 | 14 | −2.9143 |
| 8 | 16 | 0.8771 |
| 9 | 18 | −0.6583 |
| 10 | 20 | 1.3241 |
| 11 | 22 | −2.3203 |
| 12 | 24 | 0.9687 |
| 13 | 26 | −1.8437 |
| 14 | 28 | −1.3204 |
| 15 | 30 | 2.0318 |

TABLE 11
(Zoom lens unit data)

| | Initial | | Overall | Front princi- | Back princi- |
|---|---|---|---|---|---|
| Lens | surface | Focal | length of | pal points | pal points |
| unit | No. | length | lens unit | position | position |
| 1 | 1 | 4.13696 | 0.28310 | −0.04084 | 0.06657 |
| 2 | 3 | −1.76452 | 0.64370 | −0.17083 | −0.13750 |
| 3 | 9 | −1.94419 | 0.05660 | −0.00906 | 0.01430 |
| 4 | 11 | 0.96973 | 0.85400 | 0.07671 | 0.33229 |
| 5 | 22 | −2.32032 | 0.02830 | 0.01945 | 0.03203 |
| 6 | 24 | 13.50174 | 0.69650 | −6.15225 | −3.92947 |
| 7 | 30 | 2.03180 | 0.18560 | 0.05204 | 0.14112 |

TABLE 12
(Magnification of zoom lens unit)

| Lens | Initial | Wide-angle | Middle | Telephoto |
|---|---|---|---|---|
| unit | surface No. | limit | position | limit |
| 1 | 1 | 0.00000 | 0.00000 | 0.00000 |
| 2 | 3 | −0.76498 | −0.88114 | −1.35969 |
| 3 | 9 | 0.31510 | 0.30932 | 0.27139 |
| 4 | 11 | −0.96910 | −1.42004 | −1.59963 |
| 5 | 22 | 2.33791 | 3.68192 | 5.45272 |
| 6 | 24 | 0.59887 | 0.52345 | 0.45127 |
| 7 | 30 | 0.73896 | 0.53695 | 0.45695 |

### Numerical Example 3

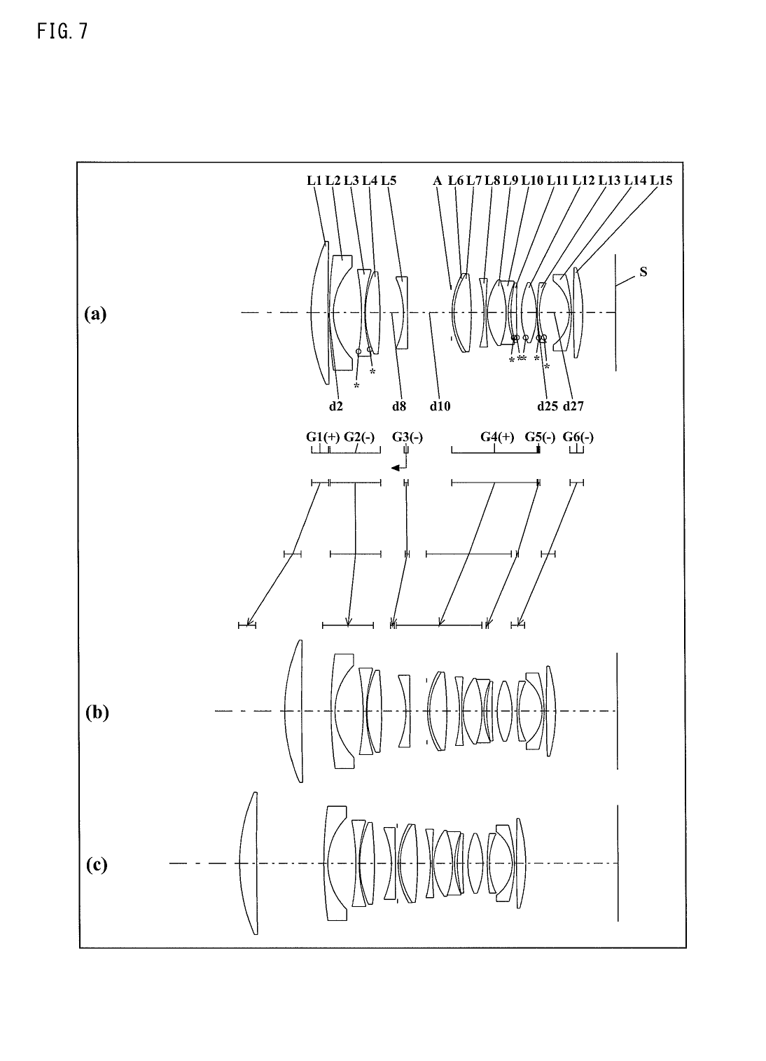

The zoom lens system of Numerical Example 3 corresponds to Embodiment 3 shown in FIG. 7. Table 13 shows the surface data of the zoom lens system of Numerical Example 3. Table 14 shows the aspherical data. Table 15 shows the various data. Table 16 shows the single lens data. Table 17 shows the zoom lens unit data. Table 18 shows the magnification of zoom lens unit.

TABLE 13
(Surface data)

| Surface number | r | d | nd | vd |
|---|---|---|---|---|
| Object surface | ∞ | | | |
| 1 | 2.55730 | 0.24270 | 1.59357 | 67.0 |
| 2 | 47.36080 | Variable | | |
| 3 | 5.86950 | 0.05660 | 1.94595 | 18.0 |
| 4 | 0.93550 | 0.40300 | | |
| 5* | −3.32240 | 0.04450 | 1.59201 | 67.0 |
| 6* | 1.90730 | 0.00990 | | |
| 7 | 1.46090 | 0.20740 | 1.94595 | 18.0 |
| 8 | −6.03230 | Variable | | |
| 9 | −1.21430 | 0.05660 | 1.69027 | 56.0 |
| 10 | −106.07940 | Variable | | |
| 11(Diaphragm) | ∞ | 0.01100 | | |
| 12 | 1.13530 | 0.02890 | 1.81518 | 20.9 |
| 13 | 1.00350 | 0.00040 | 1.56732 | 42.8 |
| 14 | 1.00350 | 0.24530 | 1.95069 | 31.1 |
| 15 | −4.70780 | 0.18390 | | |
| 16 | −1.89040 | 0.02840 | 1.78546 | 23.9 |
| 17 | 5.82330 | 0.02060 | | |
| 18 | 0.80630 | 0.26880 | 1.62105 | 62.8 |
| 19 | −1.31440 | 0.00040 | 1.56732 | 42.8 |
| 20 | −1.31440 | 0.02840 | 1.97890 | 23.5 |
| 21 | 1.08670 | 0.03940 | | |
| 22* | 1.37070 | 0.07670 | 1.88660 | 35.0 |
| 23* | 11.49460 | 0.07410 | | |
| 24* | 1.13900 | 0.21500 | 1.49710 | 81.6 |
| 25 | −1.09300 | Variable | | |
| 26* | 3.31330 | 0.02950 | 1.73152 | 52.6 |
| 27* | 1.06230 | Variable | | |
| 28 | −0.56580 | 0.02830 | 1.60236 | 64.7 |
| 29 | −1.94760 | 0.03110 | | |
| 30 | 19.47870 | 0.13270 | 1.94595 | 18.0 |
| 31 | −2.39350 | (BF) | | |
| Image surface | ∞ | | | |

TABLE 14
(Aspherical data)

Surface No. 5
K = 0.00000E+00, A4 = 7.37167E−03, A6 = −1.52598E−02,
A8 = 4.39930E−03 A10 = −5.83311E−02
Surface No. 6
K = 0.00000E+00, A4 = −8.11174E−03, A6 = −2.43267E−02,
A8 = −6.16672E−02 A10 = 2.65934E−02
Surface No. 22
K = 0.00000E+00, A4 = −5.17561E−01, A6 = −3.00951E−01,
A8 = −3.40162E−01 A10 = 2.32543E+00
Surface No. 23
K = 0.00000E+00, A4 = 1.56301E−01, A6 = −1.20791E−02,
A8 = −2.70975E−01 A10 = −4.94112E−01
Surface No. 24
K = 0.00000E+00, A4 = 1.65585E−01, A6 = 2.51091E−01,
A8 = −1.69018E+00 A10 = −2.77300E−01
Surface No. 26
K = 0.00000E+00, A4 = 6.74970E−02, A6 = 2.28148E−01,
A8 = 5.15559E−01 A10 = −3.39178E+00
Surface No. 27
K = 0.00000E+00, A4 = 1.58173E−01, A6 = 5.53141E−01,
A8 = 1.22659E+00 A10 = 1.32439E+00

TABLE 15
(Various data)
Zooming ratio 2.74561

| | Wide-angle | Middle | Telephoto |
|---|---|---|---|
| | limit | position | limit |
| Focal length | 0.9999 | 1.6568 | 2.7453 |
| F-number | 2.90358 | 2.90044 | 2.98617 |
| Half view angle | 41.6127 | 25.9705 | 16.0424 |
| Image height | 0.8090 | 0.8090 | 0.8090 |
| Overall length | 4.3515 | 4.7499 | 5.4060 |
| of lens system | | | |
| BF | 0.46363 | 0.87632 | 1.31477 |
| d2 | 0.0201 | 0.4192 | 0.9631 |
| d8 | 0.3375 | 0.3476 | 0.2430 |
| d10 | 0.6246 | 0.2421 | 0.0293 |
| d25 | 0.0118 | 0.0689 | 0.0633 |
| d27 | 0.4303 | 0.3322 | 0.3289 |
| Entrance pupil | 1.1256 | 1.6745 | 2.6169 |
| position | | | |
| Exit pupil | −1.7200 | −2.0854 | −2.5210 |
| position | | | |
| Front principal | 1.5441 | 2.0148 | 2.3722 |
| points position | | | |
| Back principal | 3.3516 | 3.0931 | 2.6607 |
| points position | | | |

TABLE 16
(Single lens data)

| Lens | Initial surface | Focal |
|---|---|---|
| element | number | length |
| 1 | 1 | 4.5450 |
| 2 | 3 | −1.1831 |
| 3 | 5 | −2.0403 |
| 4 | 7 | 1.2602 |
| 5 | 9 | −1.7799 |
| 6 | 12 | −11.7620 |
| 7 | 14 | 0.8887 |
| 8 | 16 | −1.8140 |
| 9 | 18 | 0.8457 |
| 10 | 20 | −0.6042 |
| 11 | 22 | 1.7491 |
| 12 | 24 | 1.1591 |
| 13 | 26 | −2.1494 |
| 14 | 28 | −1.3342 |
| 15 | 30 | 2.2600 |

TABLE 17
(Zoom lens unit data)

| | Initial | | Overall | Front princi- | Back princi- |
|---|---|---|---|---|---|
| Lens | surface | Focal | length of | pal points | pal points |
| unit | No. | length | lens unit | position | position |
| 1 | 1 | 4.54504 | 0.24270 | −0.00868 | 0.08203 |
| 2 | 3 | −2.58904 | 0.72140 | −0.39296 | −0.43460 |
| 3 | 9 | −1.77993 | 0.05660 | −0.00039 | 0.02272 |
| 4 | 11 | 0.90730 | 1.22130 | 0.49761 | 0.48353 |
| 5 | 26 | −2.14941 | 0.02950 | 0.02522 | 0.03758 |
| 6 | 28 | −3.72827 | 0.19210 | −0.20046 | −0.14260 |

TABLE 18
(Magnification of zoom lens unit)

| Lens | Initial | Wide-angle | Middle | Telephoto |
|---|---|---|---|---|
| unit | surface No. | limit | position | limit |
| 1 | 1 | 0.00000 | 0.00000 | 0.00000 |
| 2 | 3 | −1.19410 | −1.46348 | −2.11316 |
| 3 | 9 | 0.19879 | 0.18424 | 0.15838 |
| 4 | 11 | −0.54171 | −0.68824 | −0.78792 |
| 5 | 26 | 1.40908 | 1.48281 | 1.58802 |
| 6 | 28 | 1.21413 | 1.32482 | 1.44242 |

### Numerical Example 4

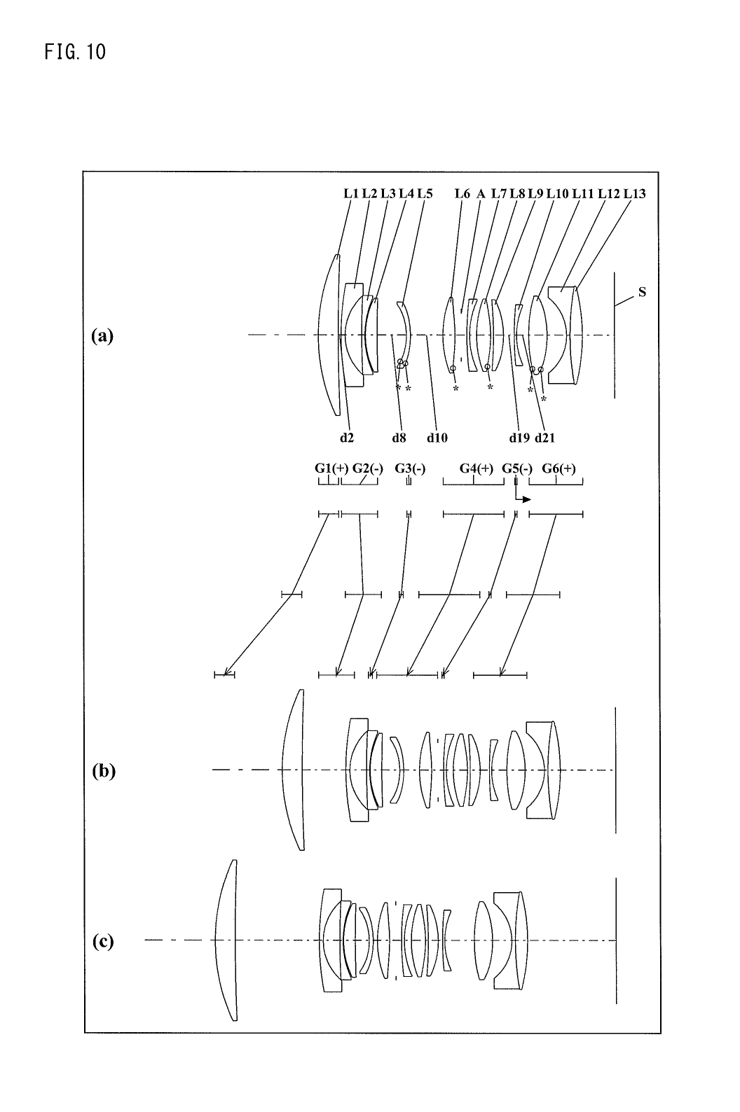

The zoom lens system of Numerical Example 4 corresponds to Embodiment 4 shown in FIG. 10. Table 19 shows the surface data of the zoom lens system of Numerical Example 4. Table 20 shows the aspherical data. Table 21 shows the various data. Table 22 shows the single lens data. Table 23 shows the zoom lens unit data. Table 24 shows the magnification of zoom lens unit.

TABLE 19
(Surface data)

| Surface number | r | d | nd | vd |
|---|---|---|---|---|
| Objet surface | ∞ | | | |
| 1 | 2.72300 | 0.28590 | 1.62041 | 60.3 |
| 2 | 26.41520 | Variable | | |
| 3 | 3.96120 | 0.05660 | 1.88300 | 40.8 |
| 4 | 0.75190 | 0.23790 | | |
| 5 | 11.35420 | 0.04450 | 1.91082 | 35.2 |
| 6 | 1.28700 | 0.00810 | | |
| 7 | 1.18120 | 0.16530 | 1.92286 | 20.9 |
| 8 | 15.47990 | Variable | | |
| 9* | −0.87710 | 0.05660 | 1.58913 | 61.3 |
| 10* | −1.33500 | Variable | | |
| 11 | 1.47410 | 0.17230 | 1.85135 | 40.1 |
| 12* | −2.66720 | 0.09080 | | |
| 13(Diaphragm) | ∞ | 0.08090 | | |
| 14 | 4.08680 | 0.04050 | 1.92286 | 20.9 |
| 15 | 1.21110 | 0.09910 | | |
| 16 | 1.45980 | 0.20230 | 1.55332 | 71.7 |
| 17* | −1.71290 | 0.04050 | | |
| 18 | −5.70790 | 0.14290 | 1.59282 | 68.6 |
| 19 | −1.14200 | Variable | | |
| 20 | 4.48840 | 0.03240 | 2.00069 | 25.5 |
| 21 | 1.01610 | Variable | | |
| 22* | 2.62310 | 0.26190 | 1.49710 | 81.6 |
| 23* | −1.48530 | 0.27730 | | |
| 24 | −0.68690 | 0.04850 | 1.58913 | 61.3 |
| 25 | 3.97540 | 0.00040 | 1.56732 | 42.8 |
| 26 | 3.97540 | 0.17520 | 1.94595 | 18.0 |
| 27 | −2.81420 | (BF) | | |
| Image surface | ∞ | | | |

TABLE 20
(Aspherical data)

Surface No. 9
K = 6.98194E−01, A4 = −2.90592E−01, A6 = 1.75458E+00,
A8 = −1.02258E+01 A10 = 2.31729E+01
Surface No. 10
K = 0.00000E+00, A4 = −4.93975E−01, A6 = 1.00262E+00,
A8 = −7.85266E+00 A10 = 1.65417E+01
Surface No. 12
K = 0.00000E+00, A4 = 3.04636E−01, A6 = −4.44296E−02,
A8 = 1.93689E−01 A10 = −6.41510E−01
Surface No. 17
K = 0.00000E+00, A4 = 2.30885E−01, A6 = 2.33780E−02,
A8 = −2.26522E−01 A10 = 7.78862E−01
Surface No. 22
K = 0.00000E+00, A4 = 2.06626E−01, A6 = −4.12939E−01,
A8 = 2.51405E+00 A10 = −5.42148E+00
Surface No. 23
K = 0.00000E+00, A4 = −9.26628E−02, A6 = −7.31286E−01,
A8 = 2.81868E+00 A10 = −6.81714E+00

TABLE 21
(Various data)
Zooming ratio 2.74163

| | Wide-angle | Middle | Telephoto |
|---|---|---|---|
| | limit | position | limit |
| Focal length | 1.0003 | 1.6560 | 2.7425 |
| F-number | 2.89760 | 2.89330 | 2.90130 |
| Half view angle | 43.9763 | 27.5523 | 17.4610 |
| Image height | 0.8750 | 0.8750 | 0.8750 |
| Overall length | 4.2318 | 4.7631 | 5.7296 |
| of lens system | | | |
| BF | 0.45743 | 0.78916 | 1.26220 |
| d2 | 0.0404 | 0.6232 | 1.2042 |
| d8 | 0.4199 | 0.2558 | 0.1989 |
| d10 | 0.4642 | 0.2257 | 0.0606 |
| d19 | 0.1544 | 0.1325 | 0.0606 |
| d21 | 0.1756 | 0.2168 | 0.4232 |
| Entrance pupil | 1.0765 | 1.9283 | 3.1277 |
| position | | | |
| Exit pupil | −1.6704 | −2.0379 | −2.7112 |
| position | | | |
| Front principal | 1.4778 | 2.2387 | 3.0967 |
| points position | | | |
| Back principal | 3.2315 | 3.1070 | 2.9871 |
| points position | | | |

TABLE 22
(Single lens data)

| Lens | Initial surface | Focal |
|---|---|---|
| element | number | length |
| 1 | 1 | 4.8710 |
| 2 | 3 | −1.0598 |
| 3 | 5 | −1.5970 |
| 4 | 7 | 1.3780 |
| 5 | 9 | −4.5490 |
| 6 | 11 | 1.1369 |
| 7 | 14 | −1.8777 |
| 8 | 16 | 1.4575 |
| 9 | 18 | 2.3805 |
| 10 | 20 | −1.3187 |
| 11 | 22 | 1.9490 |
| 12 | 24 | −0.9904 |
| 13 | 26 | 1.7640 |

TABLE 23
(Zoom lens unit data)

| | Initial | | Overall | Front princi- | Back princi- |
|---|---|---|---|---|---|
| Lens | surface | Focal | length of | pal points | pal points |
| unit | No. | length | lens unit | position | position |
| 1 | 1 | 4.87098 | 0.28590 | −0.02019 | 0.09009 |
| 2 | 3 | −1.21602 | 0.51240 | 0.00829 | 0.12890 |
| 3 | 9 | −4.54905 | 0.05660 | −0.07150 | −0.05223 |
| 4 | 11 | 0.86749 | 0.86930 | 0.39880 | 0.44527 |
| 5 | 20 | −1.31868 | 0.03240 | 0.02103 | 0.03716 |
| 6 | 22 | 6.12622 | 0.76330 | −0.45303 | −0.20890 |

TABLE 24
(Magnification of zoom lens unit)

| Lens | Initial | Wide-angle | Middle | Telephoto |
|---|---|---|---|---|
| unit | surface No. | limit | position | limit |
| 1 | 1 | 0.00000 | 0.00000 | 0.00000 |
| 2 | 3 | −0.35655 | −0.43004 | −0.54125 |
| 3 | 9 | 0.65638 | 0.66353 | 0.65604 |
| 4 | 11 | −0.52023 | −0.62121 | −0.68552 |
| 5 | 20 | 2.20015 | 2.69194 | 3.64098 |
| 6 | 22 | 0.76664 | 0.71249 | 0.63527 |

### Numerical Example 5

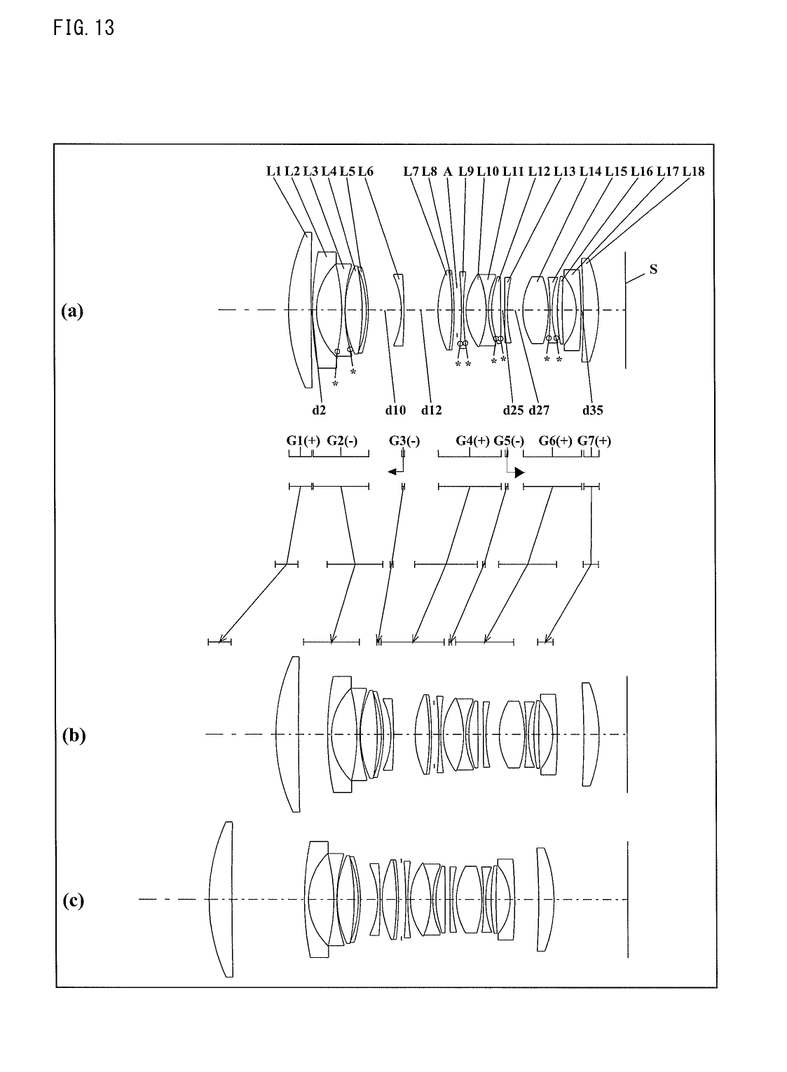

The zoom lens system of Numerical Example 5 corresponds to Embodiment 5 shown in FIG. 13. Table 25 shows the surface data of the zoom lens system of Numerical Example 5. Table 26 shows the aspherical data. Table 27 shows the various data. Table 28 shows the single lens data. Table 29 shows the zoom lens unit data. Table 30 shows the magnification of zoom lens unit.

TABLE 25
(Surface data)

| Surface number | r | d | nd | vd |
|---|---|---|---|---|
| Object surface | ∞ | | | |
| 1 | 2.65590 | 0.32360 | 1.59349 | 67.0 |
| 2 | 49.28710 | Variable | | |
| 3 | 4.21050 | 0.05660 | 2.00069 | 25.5 |
| 4 | 0.91750 | 0.36290 | | |
| 5* | −2.48950 | 0.04450 | 1.61881 | 63.9 |
| 6* | 2.06090 | 0.00420 | | |
| 7 | 1.51030 | 0.24170 | 1.92130 | 21.7 |
| 8 | −3.29090 | 0.06110 | | |
| 9 | −1.58460 | 0.02940 | 1.93651 | 23.8 |
| 10 | −2.02260 | Variable | | |
| 11 | −1.15710 | 0.03640 | 1.71300 | 53.9 |
| 12 | −7.19140 | Variable | | |
| 13 | 1.31490 | 0.20190 | 1.95375 | 32.3 |
| 14 | −3.61770 | 0.00040 | 1.56732 | 42.8 |
| 15 | −3.61770 | 0.02960 | 1.92286 | 20.9 |
| 16 | −4.54930 | 0.04050 | | |
| 17(Diaphragm) | ∞ | 0.06420 | | |
| 18* | −5.99880 | 0.02830 | 1.77250 | 49.5 |
| 19* | 3.83280 | 0.03760 | | |
| 20 | 0.87260 | 0.28860 | 1.61800 | 63.4 |
| 21 | −1.33370 | 0.00040 | 1.56732 | 42.8 |
| 22 | −1.33370 | 0.03010 | 1.93135 | 24.4 |
| 23 | 1.13800 | 0.04540 | | |
| 24* | 1.15720 | 0.13090 | 1.85135 | 40.1 |
| 25* | −43.47300 | Variable | | |
| 26 | 54.38040 | 0.03840 | 1.80518 | 25.5 |
| 27 | 1.99250 | Variable | | |
| 28 | 0.93310 | 0.36410 | 1.59282 | 68.6 |
| 29 | −1.50740 | 0.02190 | | |
| 30* | −9.27290 | 0.03250 | 1.76801 | 49.2 |
| 31* | 1.50170 | 0.07740 | | |
| 32 | 2.80960 | 0.06760 | 1.77967 | 22.0 |
| 33 | 7.21120 | 0.20320 | | |
| 34 | −0.76980 | 0.06500 | 1.62039 | 63.0 |
| 35 | −7.69990 | Variable | | |
| 36 | −11.21190 | 0.22230 | 1.94595 | 18.0 |
| 37 | −2.04100 | (BF) | | |
| Image surface | ∞ | | | |

TABLE 26
(Aspherical data)

Surface No. 5
K = 0.00000E+00, A4 = 2.26504E−02, A6 = 8.41073E−02,
A8 = −2.62857E−01 A10 = 3.14420E−01
Surface No. 6
K = 0.00000E+00, A4 =−1.34834E−02, A6 = 4.62093E−02,
A8 = −2.07442E−01 A10 = 1.13693E−01
Surface No. 18
K = 0.00000E+00, A4 = 2.17740E−02, A6 = −7.35368E−03,
A8 = 1.30486E−02 A10 = −4.66399E−01
Surface No. 19
K = 0.00000E+00, A4 = −1.41729E−02, A6 = 3.65003E−02,
A8 = −1.33289E−01 A10 = −4.71288E−01
Surface No. 24
K = 0.00000E+00, A4 = −3.59799E−01, A6 = −7.36700E−02,
A8 = −9.45146E−01 A10 = 1.16630E+00
Surface No. 25
K = 0.00000E+00, A4 = 3.09139E−02, A6 = −2.22593E−01,
A8 = 1.74404E−01 A10 = −8.22737E−01
Surface No. 30
K = 0.00000E+00, A4 = −2.28186E−01, A6 = −4.92495E−02,
A8 = 2.87679E−02 A10 = −3.91269E+00
Surface No. 31
K = 0.00000E+00, A4 = 2.18253E−01, A6 = 2.55933E−02,
A8 = 3.20852E+00 A10 = −1.03000E+01

TABLE 27
(Various data)
Zooming ratio 2.74653

| | Wide-angle | Middle | Telephoto |
|---|---|---|---|
| | limit | position | limit |
| Focal length | 1.0001 | 1.6574 | 2.7468 |
| F-number | 2.92810 | 2.92492 | 2.92476 |
| Half view angle | 40.4837 | 25.6587 | 15.7203 |
| Image height | 0.8090 | 0.8090 | 0.8090 |
| Overall length | 4.8227 | 5.0231 | 5.9831 |
| of lens system | | | |
| BF | 0.38329 | 0.39756 | 1.05325 |
| d2 | 0.0202 | 0.4172 | 1.0377 |
| d10 | 0.4729 | 0.1064 | 0.2460 |
| d12 | 0.4842 | 0.3085 | 0.0302 |
| d25 | 0.0567 | 0.0739 | 0.0675 |
| d27 | 0.2225 | 0.1904 | 0.0547 |
| d35 | 0.0322 | 0.3784 | 0.3431 |
| Entrance pupil | 1.2533 | 1.7062 | 3.0613 |
| position | | | |
| Exit pupil | −1.8886 | −2.9631 | −3.2058 |
| position | | | |
| Front principal | 1.7244 | 2.4371 | 3.4554 |
| points position | | | |
| Back principal | 3.8226 | 3.3657 | 3.2364 |
| points position | | | |

TABLE 28
(Single lens data)

| Lens | Initial surface | Focal |
|---|---|---|
| element | number | length |
| 1 | 1 | 4.7177 |
| 2 | 3 | −1.1825 |
| 3 | 5 | −1.8153 |
| 4 | 7 | 1.1514 |
| 5 | 9 | −8.0756 |
| 6 | 11 | −1.9389 |
| 7 | 13 | 1.0318 |
| 8 | 15 | −19.4395 |
| 9 | 18 | −3.0235 |
| 10 | 20 | 0.8984 |
| 11 | 22 | −0.6555 |
| 12 | 24 | 1.3258 |
| 13 | 26 | −2.5696 |
| 14 | 28 | 1.0293 |
| 15 | 30 | −1.6806 |
| 16 | 32 | 5.8643 |
| 17 | 34 | −1.3836 |
| 18 | 36 | 2.6071 |

TABLE 29
(Zoom lens unit data)

| | Initial | | Overall | Front princi- | Back princi- |
|---|---|---|---|---|---|
| Lens | surface | Focal | length of | pal points | pal points |
| unit | No. | length | lens unit | position | position |
| 1 | 1 | 4.71772 | 0.32360 | −0.01154 | 0.10951 |
| 2 | 3 | −1.89201 | 0.80040 | −0.17820 | −0.09515 |
| 3 | 11 | −1.93892 | 0.03640 | −0.00408 | 0.01101 |
| 4 | 13 | 0.98669 | 0.89790 | 0.06144 | 0.35418 |
| 5 | 26 | −2.56956 | 0.03840 | 0.02209 | 0.03921 |
| 6 | 28 | 6.07940 | 0.83170 | −2.64513 | −1.46456 |
| 7 | 36 | 2.60710 | 0.22230 | 0.13803 | 0.24743 |

TABLE 30
(Magnification of zoom lens unit)

| Lens | Initial | Wide-angle | Middle | Telephoto |
|---|---|---|---|---|
| unit | surface No. | limit | position | limit |
| 1 | 1 | 0.00000 | 0.00000 | 0.00000 |
| 2 | 3 | −0.68313 | −0.79743 | −1.07984 |
| 3 | 11 | 0.29886 | 0.30594 | 0.27654 |
| 4 | 13 | −1.04544 | −1.30798 | −1.85093 |
| 5 | 26 | 2.18899 | 2.75699 | 6.59042 |
| 6 | 28 | 0.52599 | 0.46587 | 0.26391 |
| 7 | 36 | 0.86262 | 0.85715 | 0.60565 |

### Numerical Example 6

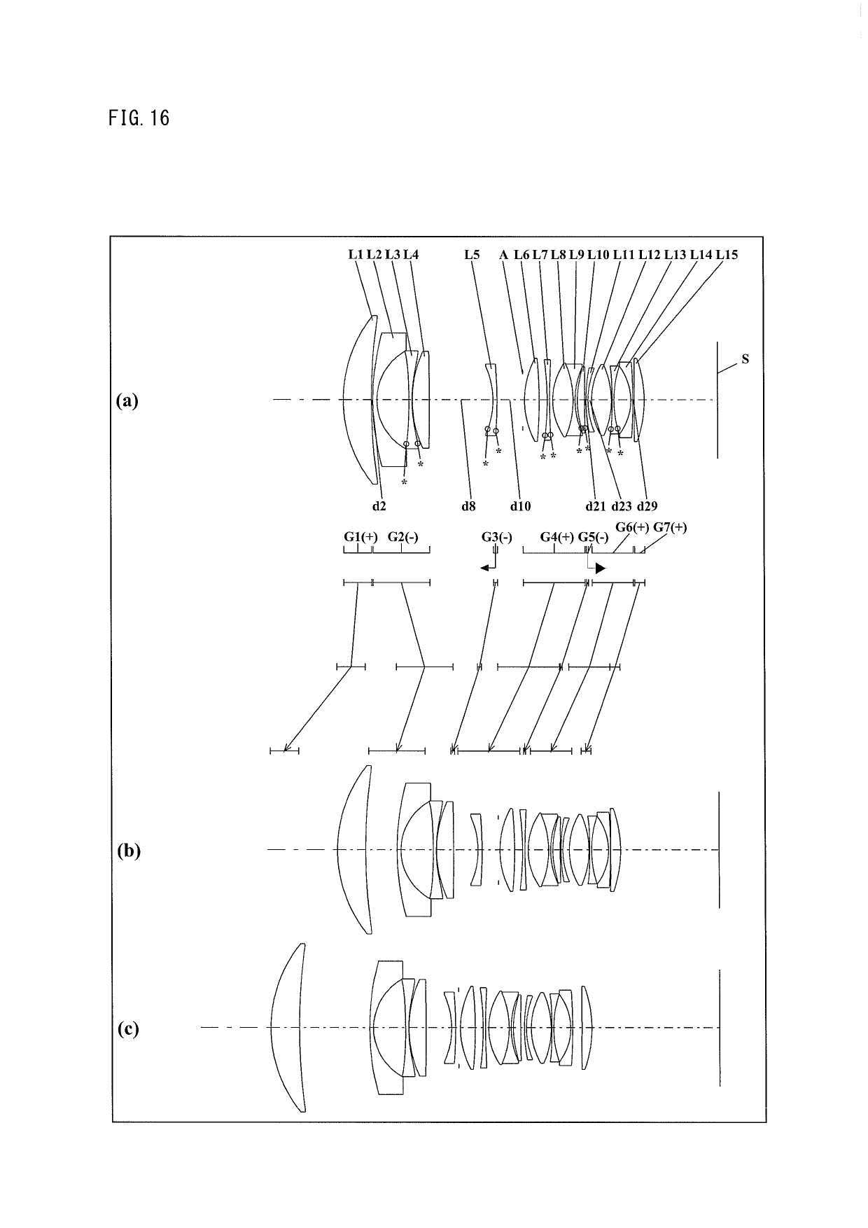

The zoom lens system of Numerical Example 6 corresponds to Embodiment 6 shown in FIG. 16. Table 31 shows the surface data of the zoom lens system of Numerical Example 6. Table 32 shows the aspherical data. Table 33 shows the various data. Table 34 shows the single lens data. Table 35 shows the zoom lens unit data. Table 36 shows the magnification of zoom lens unit.

TABLE 31
(Surface data)

| Surface number | r | d | nd | vd |
|---|---|---|---|---|
| Object surface | ∞ | | | |
| 1 | 1.91180 | 0.40450 | 1.59201 | 67.0 |
| 2 | 8.17250 | Variable | | |
| 3 | 3.54760 | 0.05660 | 2.00069 | 25.5 |
| 4 | 0.79490 | 0.45820 | | |
| 5* | −7.04100 | 0.04450 | 1.61881 | 63.9 |
| 6* | 1.87640 | 0.00440 | | |
| 7 | 1.66120 | 0.24270 | 1.94595 | 18.0 |
| 8 | −31.65540 | Variable | | |
| 9* | −1.14430 | 0.05660 | 1.71300 | 53.9 |
| 10* | −6.05170 | Variable | | |
| 11(Diaphragm) | ∞ | 0.02430 | | |
| 12 | 1.24410 | 0.20990 | 1.95375 | 32.3 |
| 13 | −6.16030 | 0.11380 | | |
| 14* | −4.08370 | 0.03430 | 1.75039 | 45.5 |
| 15* | 8.06760 | 0.04550 | | |
| 16 | 0.92790 | 0.29270 | 1.61800 | 63.4 |
| 17 | −1.28390 | 0.00040 | 1.56732 | 42.8 |
| 18 | −1.28390 | 0.02830 | 1.93355 | 23.5 |
| 19 | 1.14060 | 0.03160 | | |
| 20* | 1.22560 | 0.10470 | 1.82600 | 37.5 |
| 21* | 25.28490 | Variable | | |
| 22 | 2.36070 | 0.02830 | 1.82265 | 25.4 |
| 23 | 1.17040 | Variable | | |
| 24 | 1.00820 | 0.28310 | 1.59282 | 68.6 |
| 25 | −1.22090 | 0.00870 | | |
| 26* | −13.11430 | 0.02830 | 1.75512 | 45.6 |
| 27* | 1.57970 | 0.24270 | | |
| 28 | −0.78850 | 0.02830 | 1.57306 | 41.0 |
| 29 | −7.68010 | Variable | | |
| 30 | −73.66230 | 0.14280 | 1.94595 | 18.0 |
| 31 | −1.74790 | (BF) | | |
| Image surface | ∞ | | | |

TABLE 32
(Aspherical data)

Surface No. 5
K = 0.00000E+00, A4 = −1.85488E−02, A6 = −1.30676E−01,
A8 = 1.30161E−01 A10 = −2.93996E−01
Surface No. 6
K = 0.00000E+00, A4 = −1.01245E−01, A6 = −1.21077E−01,
A8 = −1.49203E−01 A10 = 1.40014E−02
Surface No. 9
K = 0.00000E+00, A4 = 1.82305E−02, A6 = 6.38599E−02,
A8 = 5.20333E−02 A10 = 0.00000E+00
Surface No. 10
K = 0.00000E+00, A4 = −3.81448E−03, A6 = 7.67664E−02,
A8 = 3.99512E−02 A10 = 0.00000E+00
Surface No. 14
K = 0.00000E+00, A4 = 1.96666E−02, A6 = −1.44795E−02,
A8 = −1.94200E−02 A10 = −6.48723E−02
Surface No. 15
K = 0.00000E+00, A4 = −2.12646E−02, A6 = 9.96076E−03,
A8 = −1.43539E−01 A10 = −5.70063E−02
Surface No. 20
K = 0.00000E+00, A4 = −3.95021E−01, A6 = −1.01785E−01,
A8 = −5.72416E−01 A10 = 1.32066E+00
Surface No. 21
K = 0.00000E+00, A4 = 4.46218E−02, A6 = −1.55066E−01,
A8 = 1.04878E−01 A10 = 7.71732E−01
Surface No. 26
K = 0.00000E+00, A4 = −2.05696E−01, A6 = −3.15883E−01,
A8 = 4.73596E−01 A10 = −4.33978E+00
Surface No.27
K = 0.00000E+00, A4 = 7.91496E−02, A6 = −1.43569E−01,
A8 = 1.04256E+00 A10 = −3.83383E+00

TABLE 33
(Various data)
Zooming ratio 2.74642

| | Wide-angle | Middle | Telephoto |
|---|---|---|---|
| | limit | position | limit |
| Focal length | 0.9998 | 1.6569 | 2.7458 |
| F-number | 2.90404 | 2.89750 | 2.91930 |
| Half view angle | 41.5611 | 26.5675 | 16.1477 |
| Image height | 0.8090 | 0.8090 | 0.8090 |
| Overall length | 5.3542 | 5.4558 | 6.4150 |
| of lens system | | | |
| BF | 1.04716 | 1.40662 | 1.82613 |
| d2 | 0.0202 | 0.4485 | 1.0068 |
| d8 | 0.9103 | 0.3485 | 0.3640 |
| d10 | 0.3702 | 0.2328 | 0.0447 |
| d21 | 0.0201 | 0.0115 | 0.0536 |
| d23 | 0.0509 | 0.0913 | 0.0712 |
| d29 | 0.0201 | 0.0014 | 0.1334 |
| Entrance pupil | 1.4102 | 2.0028 | 3.4546 |
| position | | | |
| Exit pupil | −2.3827 | −2.7504 | −3.6281 |
| position | | | |
| Front principal | 1.9903 | 2.6613 | 4.1219 |
| points position | | | |
| Back principal | 4.3544 | 3.7989 | 3.6692 |
| points position | | | |

TABLE 34
(Single lens data)

| Lens | Initial surface | Focal |
|---|---|---|
| element | number | length |
| 1 | 1 | 4.1165 |
| 2 | 3 | −1.0344 |
| 3 | 5 | −2.3897 |
| 4 | 7 | 1.6745 |
| 5 | 9 | −1.9887 |
| 6 | 12 | 1.1005 |
| 7 | 14 | −3.6088 |
| 8 | 16 | 0.9180 |
| 9 | 18 | −0.6434 |
| 10 | 20 | 1.5563 |
| 11 | 22 | −2.8523 |
| 12 | 24 | 0.9777 |
| 13 | 26 | −1.8655 |
| 14 | 28 | −1.5357 |
| 15 | 30 | 1.8909 |

TABLE 35
(Zoom lens unit data)

| | Initial | | Overall | Front princi- | Back princi- |
|---|---|---|---|---|---|
| Lens | surface | Focal | length of | pal points | pal points |
| unit | No. | length | lens unit | position | position |
| 1 | 1 | 4.11653 | 0.40450 | −0.07577 | 0.08061 |
| 2 | 3 | −1.44696 | 0.80640 | −0.10211 | −0.00968 |
| 3 | 9 | −1.98869 | 0.05660 | −0.00774 | 0.01566 |
| 4 | 11 | 1.04703 | 0.88550 | 0.00443 | 0.32079 |
| 5 | 22 | −2.85226 | 0.02830 | 0.03113 | 0.04373 |
| 6 | 24 | 13.26853 | 0.59110 | −4.12346 | −2.91515 |
| 7 | 30 | 1.89087 | 0.14280 | 0.07509 | 0.14458 |

TABLE 36
(Magnification of zoom lens unit)

| Lens | Initial | Wide-angle | Middle | Telephoto |
|---|---|---|---|---|
| unit | surface No. | limit | position | limit |
| 1 | 1 | 0.00000 | 0.00000 | 0.00000 |
| 2 | 3 | −0.59605 | −0.72374 | −1.00414 |
| 3 | 9 | 0.33053 | 0.35262 | 0.32812 |
| 4 | 11 | −1.49595 | −2.01908 | −2.76112 |
| 5 | 22 | 3.33652 | 9.55462 | −6.53716 |
| 6 | 24 | 0.55237 | 0.31807 | −3.18822 |
| 7 | 30 | 0.44715 | 0.25704 | 0.03518 |

The following Table 37 shows the corresponding values to the individual conditions in the zoom lens systems of each of Numerical Examples.

TABLE 37
(Values corresponding to conditions)

| | | Numerical Example | | | | | |
|---|---|---|---|---|---|---|---|
| Condition | | 1 | 2 | 3 | 4 | 5 | 6 |
| (1) | \|BF_{W}/Y_{W}\| | 0.597 | 0.601 | 0.573 | 0.572 | 0.473 | 1.294 |
| (2) | SD_{T}/SD_{W} | 1.622 | 1.462 | 1.506 | 1.587 | 1.598 | 1.368 |

The present disclosure is applicable to a digital still camera, a digital video camera, a camera for a mobile terminal device such as a smart-phone, a camera for a PDA (Personal Digital Assistance), a surveillance camera in a surveillance system, a Web camera, a vehicle-mounted camera or the like. In particular, the present disclosure is applicable to a photographing optical system where high image quality is required like in a digital still camera system or a digital video camera system.

Also, the present disclosure is applicable to, among the interchangeable lens apparatuses according to the present disclosure, an interchangeable lens apparatus having motorized zoom function, i.e., activating function for the zoom lens system by a motor, with which a digital video camera system is provided.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A zoom lens system, in order from an object side to an image side, comprising:
a first lens unit having positive optical power;
a second lens unit having negative optical power; and
subsequent lens units composed of three or more lens units and an aperture diaphragm, wherein
intervals between adjacent lens units vary in zooming from a wide-angle limit to a telephoto limit at a time of image taking,
the first lens unit is composed of two or less lens elements, and moves along an optical axis in the zooming,
three or more lens elements having negative optical power are located between the first lens unit and the aperture diaphragm, and
the following conditions (1) and (2) are satisfied:
0.30<|BF_{W}/Y_{W}|<1.39 (1)
1.10<SD_{T}/SD_{W}<2.00 (2)
where
BF_{W} is a back focal length at the wide-angle limit,
Y_{W} is a diagonal image height at the wide-angle limit, expressed by the following formula:
Y_{W}=f_{W}×tan(ω_{W}),
f_{W} is a focal length of the zoom lens system at the wide-angle limit,
ω_{W} is a half view angle at the wide-angle limit,
SD_{W} is a maximum diameter of the aperture diaphragm at the wide-angle limit, and
SD_{T} is a maximum diameter of the aperture diaphragm at the telephoto limit.

2. The zoom lens system as claimed in claim 1, wherein
the first lens unit is composed of one lens element.

3. The zoom lens system as claimed in claim 1, wherein
any lens unit or a part of any lens unit among the subsequent lens units is an image blur compensating lens unit which moves in a direction perpendicular to the optical axis to optically compensate image blur.

4. The zoom lens system as claimed in claim 3, wherein
the image blur compensating lens unit is located on the image side relative to the aperture diaphragm.

5. The zoom lens system as claimed in claim 3, wherein
the image blur compensating lens unit is composed of one lens element.

6. The zoom lens system as claimed in claim 1, wherein
a lens unit located closest to the object side among the subsequent lens units is a focusing lens unit that moves along the optical axis in focusing from an infinity in-focus condition to a close-object in-focus condition.

7. The zoom lens system as claimed in claim 1, wherein
two or more lens units among the subsequent lens units are focusing lens units that move along the optical axis in focusing from an infinity in-focus condition to a close-object in-focus condition.

8. The zoom lens system as claimed in claim 1, wherein
a lens unit located on the image side relative to the aperture diaphragm among the subsequent lens units is at least one focusing lens unit that moves along the optical axis in focusing from an infinity in-focus condition to a close-object in-focus condition.

9. The zoom lens system as claimed in claim 1, wherein
a lens unit located second from the object side among the subsequent lens units includes the aperture diaphragm.

10. The zoom lens system as claimed in claim 1, wherein
all lens units, which move along the optical axis in zooming from the wide-angle limit to the telephoto limit at the time of image taking, move such that their positions at the telephoto limit are on the object side with respect to the image surface, relative to the positions at the wide-angle limit.

11. The zoom lens system as claimed in claim 1, wherein
a lens element located closest to the image side among the subsequent lens units has positive optical power.

12. An interchangeable lens apparatus comprising:
the zoom lens system as claimed in claim 1; and
a lens mount section which is connectable to a camera body including an image sensor for receiving an optical image formed by the zoom lens system and converting the optical image into an electric image signal.

13. A camera system comprising:
an interchangeable lens apparatus including the zoom lens system as claimed in claim 1; and
a camera body which is detachably connected to the interchangeable lens apparatus via a camera mount section, and includes an image sensor for receiving an optical image formed by the zoom lens system and converting the optical image into an electric image signal.
